(19) United States
(12) Patent Application Publication
(10) Pub. No.: US 2026/0098139 A1
(43) Pub. Date: Apr. 9, 2026

(54) FOAMABLE BRANCHED POLYPROPYLENE COMPOSITIONS AND FOAMED PRODUCTS PRODUCED THEREFROM

(71) Applicant: EXXONMOBIL CHEMICAL PATENTS INC., Baytown, TX (US)

(72) Inventors: Maksim E. SHIVOKHIN, Houston, TX (US); An Ngoc-Michael NGUYEN, Pearland, TX (US); Nikola S. LAMBIC, Houston, TX (US)

(73) Assignee: EXXONMOBIL CHEMICAL PATENTS INC., Baytown, TX (US)

(21) Appl. No.: 19/115,171

(22) PCT Filed: Jul. 27, 2023
(86) PCT No.: PCT/US2023/028872

§ 371 Date: Mar. 25, 2025

Related U.S. Application Data
(60) Provisional application No. 63/377,564, filed on Sep. 29, 2022.

(51) Int. Cl. C08J 9/12

(52) U.S. Cl. CPC C08J 9/12; C08J 2201/02; C08J 2203/06; C08J 2203/14; C08J 2323/14

(57) ABSTRACT

Foamable compositions having a branched polypropylene copolymer having a g′ᵥᵢₛ value of about 0.93 or less, and a foaming agent blended with the branched polypropylene copolymer. The branched polypropylene copolymer comprises a polymerized reaction product of propylene and an α,ω-diene having five or more carbon atoms. Foamed products may comprise the foamable compositions converted to a foamed form. The g′ᵥᵢₛ value of the branched polypropylene copolymer may be about 0.8 or less in some cases.

### FIELD

The present disclosure relates to polymeric foams and, more particularly, polymeric foams comprising branched polypropylene copolymers.

### BACKGROUND

Polymeric foams may be produced by introducing a physical or chemical foaming agent into a molten polymer stream, blending the foaming agent with the polymer, and extruding the resulting mixture in a lower pressure environment while shaping into a desired product form. Exposure of the molten extrudate to the lower pressure environment causes the foaming agent to gasify (either through a chemical reaction or through simple expansion upon undergoing depressurization), thereby forming cells in the polymer to define a polymeric foam. Depending on conditions, the cells may be open or closed in form. Polymeric foams are commonly utilized in a variety of industrial applications and consumer products due to their frequent excellent mechanical properties, such as a high compressive strength, and relatively light weight. As such, polymeric foams may be beneficial in the automotive, aerospace, insulation, and packaging industries, for example.

Polyurethanes, polystyrenes, and polyethylenes are among the polymers that have traditionally been utilized in polymeric foams. Polypropylene is a relatively new entry into the polymeric foam arena. Among the properties of polypropylene making such polymers desirable for incorporation in foams include, for example, excellent heat resistance, chemical resistance, and impact resistance, as well as thermal and electrical insulation properties. Impact resistance, for example, may make foamed polypropylenes especially desirable for use in automobile manufacturing.

Not every polypropylene is suitable for foaming. Linear polypropylenes may exhibit a low melt strength, which may make cell walls produced during foaming susceptible to rupture during continued cell growth, thereby leading to ineffective foam production. Blends of linear polypropylenes with other polymers having a higher melt strength may improve the cellular structure and foaming performance. Chemical alterations may also be conducted to enhance the melt strength and foaming performance of as-formed linear polypropylenes.

Long-chain branched polymers may exhibit increased extensional hardening compared to their linear counterparts, which may improve their melt strength and foaming performance. Conventionally, linear polypropylenes are converted to branched polypropylenes through post-synthesis modifications, such as through radical-mediated processes. Although radical-mediated branching may afford branched polypropylenes having properties suitable for foaming, the extent of branching may be lower than desired, and the additional processing operation for introducing branching may increase production costs.

### SUMMARY

The present disclosure relates to foamable compositions and foamed products made thereof by converting the foamable composition into a foamed form. In various aspects, the foamable compositions comprise a branched polypropylene copolymer having a g′ᵥᵢₛ value of about 0.93 or less, the branched polypropylene copolymer comprising a polymerized reaction product of propylene and an α,ω-diene having five or more carbon atoms, and a foaming agent blended with the branched polypropylene copolymer.

In other various aspects, the present disclosure provides polymer foaming processes comprising introducing a foaming agent into a branched polypropylene copolymer having a g′ᵥᵢₛ value of about 0.93 or less, the branched polypropylene copolymer comprising a polymerized reaction product of propylene and an α,ω-diene having five or more carbon atoms, to form a foamable composition, and inducing foam formation within the foamable composition to produce a foamed product comprising a foamed form of the foamable composition.

These and other features and attributes of the disclosed foamable compositions and foamed products of the present disclosure and their advantageous applications and/or uses will be apparent from the detailed description which follows.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

To assist one of ordinary skill in the relevant art in making and using the subject matter hereof, reference is made to the appended drawings.

FIG. 1 is a plot of the small amplitude oscillatory shear (SAOS) data for a branched polypropylene copolymer fit to the Winter-Chambon model.

FIG. 2 is a plot of expansion ratio as a function of temperature for various branched polypropylene copolymers and comparative commercial polypropylenes.

FIG. 3 is a plot of the cell density as a function of temperature for various branched polypropylene copolymer foams and comparative commercial polypropylene foams.

FIGS. 4A-4D are plots of the average cell diameter as a function of temperature for various branched polypropylene copolymer foams.

### DETAILED DESCRIPTION

The present disclosure relates to polymeric foams and, more particularly, polymeric foams comprising branched polypropylene copolymers.

As discussed above, polymeric foams containing branched polypropylenes may be utilized in a number of industries due the high melt strength of these types of polymers. Branching is often introduced to a substantially linear polypropylene following reactor production thereof, such as through a radical-mediated process. Polypropylene branching introduced in this manner may add significantly to production costs, and the amount of branching introduced may be inadequate in some cases.

In contrast to conventional polypropylene foams and foamable compositions produced from polypropylenes that have been modified post-synthesis to introduce branching, the present disclosure provides polypropylene foams and foamable compositions in which extensive long-chain branching is introduced during a polymerization process to form a branched polypropylene copolymer. Such branched polypropylene copolymers may be referred to herein as “in-reactor” branched polypropylene copolymers and/or as being “in-reactor” produced. In particular, branched polypropylene copolymers may be produced in-reactor by copolymerization of propylene and an α,ω-diene to form long-chain branches arising from the α,ω-diene. Such copolymerization processes may be facilitated by catalysts that are tolerant toward and promote ready polymerization of α,ω-dienes, as discussed further herein. Due to their in-reactor production, the branched polypropylene copolymers may provide an enhanced and economical approach for producing foamable compositions containing a polypropylene for batch-, extrusion-, blow molding-, and injection molding-based fabrication processes.

Branched polypropylene copolymers produced through in-reactor processes may possess several advantages over linear polypropylenes that have undergone post-synthesis modifications, such as through radical-mediated modifications to introduce branching and afford increased melt strength values. In comparison to linear polypropylenes, branched polypropylenes having higher melt strengths may afford polymeric foams having higher cell counts and, by extension, a smaller cell size. These features may afford foamable compositions comprising branched polypropylenes that exhibit high expansion ratios over a broad range of temperatures. In-reactor production of branched polypropylene copolymers, as described further herein, may furthermore be less costly and less labor-intensive than introducing branching through post-synthesis modifications.

### Definitions

All numerical values within the detailed description and the claims herein are modified by “about” or “approximately” with respect to the indicated value, and take into account experimental error and variations that would be expected by a person having ordinary skill in the art. Unless otherwise indicated, room temperature is about 23° C.

As used in the present disclosure and claims, the singular forms “a,” “an,” and “the” include plural forms unless the context clearly dictates otherwise. The term “and/or” as used in a phrase such as “A and/or B” herein is intended to include “A and B,” “A or B,” “A,” and “B.”

For the purposes of the present disclosure, the new numbering scheme for groups of the Periodic Table is used. In said numbering scheme, the groups (columns) are numbered sequentially from left to right from 1 through 18, excluding the f-block elements (lanthanides and actinides). Under this scheme, the term “transition metal” refers to any atom from Groups 3-12 of the Periodic Table, inclusive of the lanthanides and actinide elements. Ti, Zr, and Hf are Group 4 transition metals, for example.

A “straight-chain polypropylene” or “linear polypropylene” comprises a polymer backbone resulting from polymerization of polymerization of propylene and optionally one or more additional ethylenically unsaturated monomers, and at least methyl group branches extending from the polymer backbone, wherein the methyl group branches originate from the propylene. A “branched polypropylene” contains further branches in addition to the methyl group branches. Branched polypropylenes of the present disclosure may have a branching index, as measured by a g′ᵥᵢₛ value, lower than the branching index resulting from homopolymerization of propylene under similar conditions. As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, and Mz) are in units of g/mol (g·mol⁻¹). Procedures for determining polymer molecular weights are specified below.

For the purposes of the present disclosure, and unless otherwise specified, a “catalyst system” is a combination of at least one catalyst compound, at least one activator, an optional co-activator, and an optional support material. The catalyst compound may comprise a transition metal. When “catalyst system” is used to describe such a pair before activation, it refers to the unactivated catalyst complex (precatalyst) together with an activator and, optionally, a co-activator. When this term is used to describe such a pair after activation, it refers to the activated complex and the activator or other charge-balancing moiety. The transition metal compound may be neutral as in a precatalyst, or a charged species with a counter ion as in an activated catalyst system. For the purposes of the present disclosure, and unless otherwise specified, when catalyst systems are described as comprising neutral stable forms of the components, it is well understood by one of ordinary skill in the art that the ionic form of the component is the form that reacts with the monomers to produce polymers. A polymerization catalyst system is a catalyst system that can polymerize monomers to polymer. Furthermore, catalyst compounds and activators represented by formulae herein embrace both neutral and ionic forms of the catalyst compounds and activators.

For the purposes of the present disclosure, and unless otherwise specified, an “olefin,” alternatively referred to as “alkene,” is a linear, branched, or cyclic compound of carbon and hydrogen having at least one double bond. For purposes of this disclosure, when a polymer or copolymer is referred to as comprising an olefin, the olefin present in such polymer or copolymer is the polymerized form of the olefin. For example, when a copolymer is said to have a “propylene” content of 35 wt % to 55 wt %, it is understood that the mer unit in the copolymer is derived from propylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers. “Different” as used to refer to mer units indicates that the mer units differ from each other by at least one atom or are different isomerically. A “propylene polymer” or “propylene copolymer” is a polymer or copolymer comprising at least 50 mol % propylene-derived units, and so on.

For the purposes of the present disclosure, and unless otherwise specified, the term “Cₙ” refers to hydrocarbon(s) having n carbon atom(s) per molecule, wherein n is a positive integer. The term “hydrocarbon” refers to a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ−C_{y}” group or compound refers to a group or compound comprising carbon atoms at a total number thereof in the range from m to y. Thus, a C₁-C₅₀ alkyl group refers to an alkyl group comprising carbon atoms at a total number thereof in the range from 1 to 50.

For the purposes of the present disclosure, and unless otherwise specified, the terms “group,” “radical,” and “substituent” may be used interchangeably.

For the purposes of the present disclosure, and unless otherwise specified, the terms “hydrocarbyl radical,” “hydrocarbyl group,” or “hydrocarbyl” may be used interchangeably and are defined to mean a group consisting of hydrogen and carbon atoms only. Suitable hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and aryl groups, such as phenyl, benzyl, and naphthyl.

For the purposes of the present disclosure, and unless otherwise specified, the terms “alkyl radical” and “alkyl” are used interchangeably throughout this disclosure. For purposes of the present disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like including their substituted analogues.

The term “alpha-olefin” refers to an olefin having a terminal carbon-carbon double bond in the structure thereof ((R¹R²)—C═CH₂, where R¹ and R² can be independently hydrogen or any hydrocarbyl group; preferably R¹ is hydrogen and R² is an alkyl group). A “linear alpha-olefin” is an alpha-olefin defined in this paragraph, wherein R¹ is hydrogen, and R² is hydrogen or a linear alkyl group.

For the purposes of the present disclosure, and unless otherwise specified, ethylene shall be considered an α-olefin.

For the purposes of the present disclosure, and unless otherwise specified, the terms “alkoxy” and “alkoxide” mean an alkyl or aryl group bound to an oxygen atom, such as an alkyl ether or aryl ether group/radical connected to an oxygen atom and can include those where the alkyl/aryl group is a C₁-C₁₀ hydrocarbyl. The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, and phenoxy.

For the purposes of the present disclosure, and unless otherwise specified (such as for “substituted hydrocarbyl”, etc.), the term “substituted” refers to that at least one hydrogen atom has been replaced with at least one non-hydrogen group, such as a hydrocarbyl group, a heteroatom, or a heteroatom-containing group, such as halogen (such as Br, Cl, F or I) or at least one functional group such as —NR*₂, —OR*, —SeR*, —TeR*, —PR*₂, —ASR*₂, —SbR*₂, —SR*, —BR*₂, —SiR*₃, —GeR*₃, —SnR*₃, —PbR*₃, —(CH₂)_{q}—SiR*₃, where q is 1 to 10 and each R* is independently hydrogen, a hydrocarbyl or halocarbyl radical, or two or more R* may join together to form a substituted or unsubstituted saturated, partially unsaturated, or aromatic cyclic or polycyclic ring structure), or where at least one heteroatom has been inserted within a hydrocarbyl ring.

For the purposes of the present disclosure, the term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(C)_{q}SiR*, or the like where q is 1 to 10 and each R* is independently hydrogen, a hydrocarbyl or halocarbyl radical, and two or more R* may join together to form a substituted or unsubstituted saturated, partially unsaturated, or aromatic cyclic or polycyclic ring structure), or where at least one heteroatom has been inserted within a hydrocarbyl ring.

For the purposes of the present disclosure, and unless otherwise specified, the term “ring atom” refers to an atom that is part of a cyclic ring structure. By this definition, a benzyl group has six ring atoms and tetrahydrofuran has five ring atoms.

For the purposes of the present disclosure, and unless otherwise specified, the term “aryl” or “aryl group” refers to an aromatic ring such as phenyl, naphthyl, xylyl, and the like. Likewise, heteroaryl refers to an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic.

For the purposes of the present disclosure, and unless otherwise specified, the term “substituted aryl,” means an aryl group having one or more hydrogen groups replaced by a hydrocarbyl, substituted hydrocarbyl, heteroatom or heteroatom containing group.

For the purposes of the present disclosure, and unless otherwise specified, the term “substituted heteroaryl,” means a heteroaryl group having one or more hydrogen groups replaced by a hydrocarbyl, substituted hydrocarbyl, heteroatom or heteroatom containing group.

For the purposes of the present disclosure, and unless otherwise specified, a “halocarbyl” is a halogen-substituted hydrocarbyl group that may be bound to another substituent via a carbon atom or a halogen atom.

For the purposes of the present disclosure, and unless otherwise specified, where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The following abbreviations may be used herein: Me is methyl, Ft is ethyl, Pr is propyl, cPR is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, MAO is methylalumoxane, dme is 1,2-dimethoxyethane, p-tBu is para-tertiary butyl, TMS is trimethylsilyl, TIBAL is triisobutylaluminum, TNOAL is tri (n-octyl) aluminum, p-Me is para-methyl, Bz and Bn arc benzyl (i.e., CH₂Ph), THF (also referred to as thf) is tetrahydrofuran, RT is room temperature (and is 23° C. unless otherwise indicated), tol is toluene, EtOAc is ethyl acetate, Cbz is Carbazole, and Cy is cyclohexyl.

In the description herein, the catalyst may be described as a catalyst, a catalyst precursor, a pre-catalyst compound, catalyst compound or a transition metal compound. These terms may be used interchangeably. The terms “cocatalyst” and “activator” are used herein interchangeably.

For the purposes of the present disclosure, and unless otherwise specified, an “anionic ligand” is a negatively charged ligand which donates one or more pairs of electrons to a metal ion. A “neutral donor ligand” is a neutrally charged ligand which donates one or more pairs of electrons to a metal ion.

For the purposes of the present disclosure, and unless otherwise specified, a heterocyclic ring is a ring having a heteroatom in the ring structure, as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

For the purposes of the present disclosure, and unless otherwise specified, a scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In at least one embodiment a co-activator can be pre-mixed with the transition metal compound to form an alkylated transition metal compound.

For the purposes of the present disclosure, and unless otherwise specified, a “metallocene” catalyst compound is a transition metal catalyst compound having one, two or three, typically one or two, substituted or unsubstituted cyclopentadienyl ligands bound to the transition metal, typically a metallocene catalyst is an organometallic compound containing at least one p-bound cyclopentadienyl moiety (or substituted cyclopentadienyl moiety). Substituted or unsubstituted cyclopentadienyl ligands include substituted or unsubstituted indenyl, fluorenyl, indacenyl, benzindenyl, and the like.

For the purposes of the present disclosure, and unless otherwise specified, the term “continuous” refers to a system that operates without interruption or cessation. For example a continuous process to produce a polymer would be one where the reactants are continually introduced into one or more reactors and polymer product is continually withdrawn.

For the purposes of the present disclosure, and unless otherwise specified, the term “in-reactor polypropylene” or “in-reactor branched polypropylene” means a polypropylene polymer or copolymer produced in one or a plurality of polymerization stages without a post-polymerization synthetic modification being conducted upon the polypropylene chain. Although the various polymerization stages may be conducted in different polymerization zones, that is in different reactors or different parts of the same reactor, the stages may alternately be conducted sequentially in the same polymerization zone. A polymerization zone is defined as an area where activated catalysts and monomers are contacted and a polymerization reaction takes place. When multiple reactors are used in either series or parallel configuration, each reactor is considered as a separate polymerization zone.

For the purposes of the present disclosure, and unless otherwise specified, a composition that is “foamable” means that foam formation has not yet taken place, but the composition is capable of forming a foam once exposed to suitable conditions. A “foamed composition” or “foamed product,” in contrast, means that foam formation has taken place to introduce a plurality of cells within a polymer within the composition.

For the purposes of the present disclosure, and unless otherwise specified, the term “α,ω-diene” refers to an olefinic compound having two terminal alkene groups located at opposite ends of a hydrocarbon chain.

Unless otherwise specified, branching indices herein are specified as a g′ᵥᵢₛ value. A given g′ᵥᵢₛ value may be determined by gel permeation chromatography (GPC)-4D.

### Branched Polypropylene Copolymers, Polymerization Processes, and Catalyst Compounds

Branched polypropylene copolymers suitable for use in the present disclosure may comprise a polymerized reaction product of propylene and an α,ω-diene having five or more carbon atoms. The branched polypropylene copolymer may have a g′ᵥᵢₛ value of about 0.93 or less, preferably about 0.9 or less or about 0.8 or less, which is characteristic of the amount of branching. Foamable compositions may be produced by blending the branched polypropylene copolymer with a foaming agent.

The branched polypropylene copolymers suitable for use herein may be produced through polymerization processes in which propylene is copolymerized with at least one additional comonomer. More specifically, the polymerization processes may copolymerize propylene with at least one α,ω-diene, and optionally with at least one additional comonomer. The propylene and the additional comonomer(s) may be introduced to (or contacted with) a catalyst system described herein including an activator and at least one catalyst compound, wherein the at least one catalyst compound is suitable for polymerizing α,ω-dienes. The catalyst compound and activator may be combined to form a catalyst system prior to contacting the monomers. Alternately, the catalyst compound and activator may be introduced into the polymerization reactor separately, wherein they subsequently react to form a catalyst system.

The branched polypropylene copolymers disclosed herein may comprise propylene in an amount of about 50 wt % or above, or about 55 wt % or above, or about 60 wt % or above, or about 65 wt % or above, or about 70 wt % or above, or about 75 wt % or above, or about 80 wt % or above, or about 85 wt % or above, or about 90 wt % or above, or about 99 wt % or above, or about 99.5 wt % or above, provided that the α,ω-diene is present in a non-zero amount within the branched polypropylene copolymer. In some embodiments, the at least one α,ω-diene may comprise a balance of the mass in the branched polypropylene copolymer, and in other embodiments, at least one additional comonomer may be present in addition to the at least one α,ω-diene. In particular embodiments, the branched polypropylene copolymer may comprise or consist essentially of about 90 wt % or above propylene and a non-zero amount of the at least one α,ω-diene, based on total mass of the branched polypropylene copolymer, preferably about 99 wt % or above propylene and a non-zero amount of the at least one α,ω-diene, based on total mass of the branched polypropylene copolymer. In some embodiments, the non-zero amount of the at least one α,ω-diene may range from about 0.001 wt % to about 10 wt %, or about 0.01 wt % to about 9.99 wt %, or about 0.1 wt % to about 9.9 wt %, or about 0.5 wt % to about 99.5 wt %, or about 0.1 wt % to about 10 wt %, or any subrange thereof, based on total mass of the branched polypropylene copolymer.

Specific examples of suitable α,ω-dienes may include, but are not limited to, 1,4-pentadiene, 1,5-hexadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, 2-methyl-1,6-heptadiene, 2-methyl-1,7-octadiene, 2-methyl-1,8-nonadiene, 2-methyl-1,9-decadiene, 2-methyl-1,10-undecadiene, 2-methyl-1,11-dodecadiene, 2-methyl-1, 12-tridecadiene, and 2-methyl-1,13-tetradecadiene.

In addition to a, w-dienes, the branched polypropylene copolymers may include at least one additional co-monomer such as one or more α-olefins and/or or more diene monomers. Suitable diene monomers may include any type of diene other than a α, ω-diene. Suitable α-olefins may include ethylene or substituted or unsubstituted C₄-C₄₀ alpha olefins, such as C₄-C₂₀ alpha olefins or C₄-C₁₂ alpha olefins, such as 1-butene, 1-pentene, 1-hexene, 1-heptene, 1-octene, 1-nonene, 1-decene, 1-undecene, 1-dodecene, and isomers thereof, including branched isomers. Other illustrative monomers that may be present in the branched polypropylene copolymers may include, for example, norbornene, ethylidenenorbornene, vinylnorbornene, norbornadiene, dicyclopentadiene, cyclopentadiene, cyclopentene, cycloheptene, cyclooctene, cyclooctadiene, cyclododecene, divinylbenzene, 7-oxanorbornene, 7-oxanorbornadiene, substituted derivatives thereof, and isomers thereof, such as cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, butadiene, hexadiene, heptadiene, octadiene, nonadiene, decadiene, undecadiene dodecadiene and their respective homologs and derivatives.

When present, one or more dienes other than α,ω-dienes may be present in the branched polypropylene copolymers in an amount up to about 10 wt % or up to about 1 wt % based on total mass of the branched polypropylene copolymers, such as about 0.00001 wt % to about 1.0 wt %, or about 0.002 wt % to about 0.5 wt %, or about 0.003 wt % to about 0.2 wt %, based upon total mass of the branched polypropylene copolymer. In at least one embodiment 500 ppm or less of diene may be added to the polymerization reactor, such as 400 ppm or less, such as 300 ppm or less. In other embodiments at least 50 ppm of diene may be added to the polymerization, or 100 ppm or more, or 150 ppm or more. Alternately, one or more dienes may be present at 0.1 to 1 mol %, such as 0.5 mol %.

In-reactor polymerization processes of the present disclosure may be carried out in any manner known in the art that may suitably produce the branched polypropylene copolymers. Any suspension, homogeneous, bulk, solution, slurry, or gas phase polymerization process known in the art can be used. Such processes can be ran in a batch, semi-batch, or continuous mode. Homogeneous polymerization processes and slurry processes can be employed. A homogeneous polymerization process refers to a process where at least 90 wt % of the product is soluble in the reaction media. A homogeneous polymerization process can be a bulk homogeneous process. A bulk process refers to a process where monomer concentration in all feeds to the reactor is 70 vol % or more. Alternately, no solvent or diluent is present or added in the reaction medium, (except for the small amounts used as the carrier for the catalyst system or other additives, or amounts typically found with the monomer; e.g., propane in propylene). In another embodiment, the process is a slurry process. As used herein, the term “slurry polymerization process” refers to a polymerization process where a supported catalyst is employed and monomers are polymerized on the supported catalyst particles. At least 95 wt % of polymer products derived from the supported catalyst are in granular form as solid particles (not dissolved in the diluent).

Suitable diluents/solvents for polymerization processes include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (ISOPAR™ fluids); perhalogenated hydrocarbons, such as perfluorinated C₄-C₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, such as aromatics are present in the solvent at less than 1 wt %, such as less than 0.5 wt %, or even 0 wt % based upon the weight of the solvents.

In at least one embodiment, the feed concentration of the monomers and co-monomers for the polymerization may comprise 60 vol % solvent or less, or 40 vol % or less, or 20 vol % or less, based on the total volume of the feed stream.

Polymerizations can be conducted at any temperature and/or pressure suitable to obtain the desired branched polypropylene copolymers. Suitable temperatures and/or pressures may include a temperature in a range from about 0° C. to about 300° C., such as about 20° C. to about 200° C., or about 35° C. to about 150° C., or about 40° C. to about 120° C., or about 45° C. to about 80° C.; and at a pressure in the range of about 0.35 MPa to about 10 MPa, or about 0.45 MPa to about 6 MPa, or about 0.5 MPa to about 4 MPa.

In suitable polymerizations, the run time of the reaction can be up to 300 minutes, such as in the range of about 5 minutes to about 250 minutes, or about 10 minutes to about 120 minutes. In a continuous process, the run time may be the average residence time of the reactor.

In at least one embodiment, hydrogen may be present in the polymerization reactor at a partial pressure of 0.001 psig to 50 psig (0.007 kPa to 345 kPa), such as from 0.01 psig to 25 psig (0.07 kPa to 172 kPa), or 0.1 psig to 10 psig (0.7 kPa to 70 kPa).

In some embodiments, the activity of the catalyst may be at least 50 g/mmol/hour, such as 1,000 g/mmol/hour or more, 5,000 g/mmol/hr or more, or 50,000 g/mmol/hr or more, or 100,000 g/mmol/hr or more, or 500,000 g/mmol/hr or more. In an alternative embodiment, the conversion of olefin monomer may be at least 10%, based upon polymer yield and the weight of the monomer entering the reaction zone, such as 20% or more, or 30% or more, or 50% or more, or 80% or more.

In some embodiments, the branched polypropylene copolymers produced herein can have an Mw of about 5,000 to about 1,000,000 g/mol, such as about 25,000 to about 750,000 g/mol, or about 50,000 to about 500,000 g/mol, or about 80,000 to about 300,000 g/mol, or about 80,000 to about 200,000 g/mol), as determined by GPC-4D. In some embodiments, the branched polypropylene copolymers produced herein can have an Mn of about 1,000 to about 100,000 g/mol, such as about 10,000 to about 100,000 g/mol, or about 20,000 to about 80,000 g/mol, or about 30,000 to about 75,000 g/mol, or about 25,000 to about 85,000 g/mol), as determined by GPC-4D. In some embodiments, the branched polypropylene copolymers can have a molecular weight distribution (MWD) (Mw/Mn) of greater than about 1, such as about 1 to about 40, or about 1.5 to about 20, or about 2 to about 10, as determined by GPC-4D. Preferably, Mw/Mn is about 9 or less, such as about 1 to about 9, or about 2 to about 8, or about 3 to about 7.

In some embodiments, the branched polypropylene copolymers produced herein can have an Mz of about 100,000 to about 10,000,000 g/mol, such as about 100,000 to about 5,000,000 g/mol, or about 200,000 to about 1,000,000 g/mol, or about 1,000,000 to about 3,000,000 g/mol, or about 1,500,000 to about 3,000,000 g/mol, as determined by GPC-4D. In some embodiments, the branched polypropylene copolymers can have a Mz/Mw of about 6 or less, such as about 1 to about 6, or about 2 to about 5, or about 3 to about 6, or about 1 to about 3.

In some embodiments, the branched polypropylene copolymers can have a g′ᵥᵢₛ of 0.5 or more and less than 0.8, or less than 0.85, or less than 0.9, or less than 0.93, such as from about 0.5 to about 0.93, or about 0.5 to about 0.8, or about 0.5 to about 0.75, or about 0.5 to about 0.7, or about 0.5 to about 0.65, or about 0.5 to about 0.6, or about 0.6 to about 0.8, or about 0.65 to about 0.8, or about 0.7 to about 0.8, or about 0.75 to about 0.93, or about 0.8 to about 0.9, as determined by GPC-4D.

In some embodiments, the branched polypropylene copolymers can have a melt flow rate (MFR) of about 0.4 dg/min to about 56 dg/min, or about 0.4 dg/min to about 30 dg/min, or about 0.4 dg/min to about 10 dg/min, or about 0.4 dg/min to about 3.6 dg/min, or about 0.6 dg/min to about 3.0 dg/min, or about 1 dg/min to about 2.5 dg/min, as determined by ASTM D1238 (230° C., 2.16 kg).

In some embodiments, the branched polypropylene copolymers can have a g′ᵥᵢₛ of about 0.8 or less and a MFR of about 0.4 dg/min to about 3.6 dg/min, as determined by ASTM D1238 (230° C., 2.16 kg).

In some embodiments, the branched polypropylene copolymers can have a Tm of greater than about 145° C., such as about 150° C. to about 165° C., or about 155° C. to about 162° C., or about 158° C. to about 160° C., as determined by differential scanning calorimetry as described below. In some embodiments, the branched polypropylene copolymer can have a Tm of about 148° C. to about 159° C.

In some embodiments the branched polypropylene copolymers can have a shear thinning ratio (STR) of about 0.15 to about 0.007, or about 0.1 to about 0.01, or about 0.075 to about 0.025, as measured as shear viscosity ratio between radial frequencies of 100 rad/s and 0.1 rad/s. Alternately, the branched polypropylene copolymer may have a shear thinning ratio of about 0.007 to about 0.12.

Shear thinning can be described by the following parameters: Power Law Index (slope of the viscosity vs frequency in the power-law regime), transition index (parameter describing the transition between Newtonian plateau and power law region), consistency (characteristic relaxation time of the polymer, inverse to the frequency correspondent to the transition from Newtonian to power-law regime), infinite-rate viscosity, zero-shear viscosity as defined by fitting dependence of complex viscosity on angular frequency data by Carreau-Yasuda model. These parameters can be calculated using Equation 1:

$$\frac{η \times ( ω ) - {η}_{∞}}{{η}_{0} - {η}_{∞}} = \frac{1}{{[ 1 + {( k ω )}^{a} ]}^{( 1 - n ) / a}} \qquad Equation 1$$

wherein η₀ is the zero-shear viscosity, η_{∞} is the infinite viscosity, k is the consistency, η is the power law index, and a is the transition index.

In at least one embodiment, the branched polypropylene copolymers produced herein, as measured at 190° C., and at radial frequencies between 0.1 and 628 rad/s can have one or more of the following:
a. a power law index, η_{CY}, of from, about −1.0 to about 0.25, such as about −1.1 to about 0.23;
b. a transition index, a_{CY}, of from about 0.09 to about 0.3, such as about 0.1 to about 0.2;
c. a consistency, k_{CY}, of from such as about 1.0e⁻⁴ s to about 17.0, such as about 1.2e⁻⁴ s to about 16.3;
d. an infinite-rate viscosity, η_{∞CY}, of from about −140 Pa·s to about 42 Pa·s, such as about −132.6 Pas to about 31.9 Pa·s; and/or
e. a zero-shear viscosity, η_{0CY}, of from about 14 kPa·s to about 3,200 kPa·s, such as about 16 kPa·s to about 3000 kPa·s, as defined by fitting dependence of complex viscosity on angular frequency data by Carreau-Yasuda model using TA Instruments Trios v3.3.1.4246 software with high quality of fits as indicated by high value of parameter R2 (>0.9999).

In at least one embodiment, the branched polypropylene copolymers may have a strain hardening ratio (SHR) of about 25 or less, or about 20 or less, such as about 15 to about 5, as determined using a first strain rate of 1 sec⁻¹ a second strain rate of 0.1 sec⁻¹, and a time of 2.5 seconds for both rates. Strain hardening ratio is determined as described below.

In at least one embodiment, the branched polypropylene copolymers may have a complex viscosity as measured by oscillatory shear at a radial frequency of 100 rad/s of 140 Pa·s to 2,000 Pa·s, or about 180 Pa·s to 1,600 Pas, or about 240 Pa·s to about 1,400 Pa·s, or about 25 Pa·s to about 500 Pa·s, or about 50 Pas to about 350 Pa·s.

In at least one embodiment, the branched polypropylene copolymers may have a complex viscosity as measured by oscillatory shear at a radial frequency of 0.1 rad/s of about 1,000 Pa·s to about 80,000 Pa·s, or about 1,500 Pa·s to about 70,000 Pa·s, or about 2,000 Pa·s to about 60,000 Pa·s.

In at least one embodiment, the branched polypropylene copolymers may have a 1% Secant flexural modulus of about 1,300 MPa to about 2,300 MPa., or about 1,500 MPa to about 2,200 MPa, or about 1,700 MPa to about 2,130 MPa.1% Secant flexural modulus is measured using an ISO 37-Type 3 bar, with a crosshead speed of 1.0 mm/min and a support span of 30.0 mm using an Instron machine according to ASTM D 790 (A, 1.0 mm/min).

In at least one embodiment, the branched polypropylene copolymers may have a Hencky strain of 2.5 and at a Hencky strain rate of 1.0 s⁻¹ has an extensional viscosity of about 700 kPa·s or less, measured at 190° C., or about 400 kPa·s to about 650 kPa·s, or about 450 kPa·s to about 600 kPa·s.

In at least one embodiment, the branched polypropylene copolymers may have a unimodal or multimodal molecular weight distribution as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versa).

The branched propylene copolymers may have some level of isotacticity, and can be isotactic or highly isotactic. As used herein, “isotactic” is defined as having at least 10% isotactic pentads according to analysis by ¹³C NMR, as described in US 2008/0045638. As used herein, “highly isotactic” is defined as having at least 60% isotactic pentads according to analysis by ¹³C NMR. In another embodiment, the branched polypropylene copolymer produced can be atactic. Atactic polypropylene is defined to be less than 10% isotactic or syndiotactic pentads according to analysis by ¹³C NMR.

Suitable catalyst compounds for producing the branched polypropylene copolymers may have a structure represented by Formula 1:

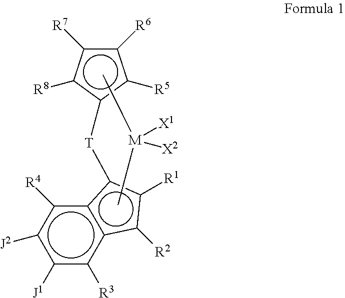

wherein M is a transition metal atom; T is a bridging group; each of X¹ and X² is a univalent anionic ligand, or X¹ and X² are joined to form a metallocycle ring; R¹ is hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl; R³ is an unsubstituted C₄-C₆₂ cycloalkyl, a substituted C₄-C₆₂ cycloalkyl, an unsubstituted C₄-C₆₂ aryl, a substituted C₄-C₆₂ aryl, an unsubstituted C₄-C₆₂ heteroaryl, or a substituted C₄-C₆₂ heteroaryl; each of R² and R⁴ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl; each of R⁵, R⁶, R⁷, and R⁸ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or one or more of R⁵ and R⁶, R⁶ and R⁷, or R⁷ and R⁸ can be joined to form a substituted or unsubstituted C₄-C₆₂ saturated or unsaturated cyclic or polycyclic ring structure, or a combination thereof; and each of J¹ and J² is joined to form a substituted or unsubstituted C₄-C₆₂ (alternately C₅-C₆₂, alternately C₅-C₄₀, alternately C₆ to C₃₀, alternately C₆ to C₂₀) unsaturated cyclic or polycyclic ring structure, or a combination thereof, provided that J¹ and J² together with the two carbons they are bound to on the indenyl group form at least one saturated ring. Preferably, J¹ and J² together with the two carbons they are bound to on the indenyl group form at least one 5 or 6 membered saturated ring.

As a non-limiting illustration, in Formula 1 the phrase “J¹ and J² together with the two carbons they are bound to on the indenyl group” means that the J¹ and J² groups and the carbon atoms in the box in Formula 2 below. Preferably, the atoms in the box form a 5- or 6-membered saturated ring, indacenyl and hexahydrobenz[f]indenyl, respectively.

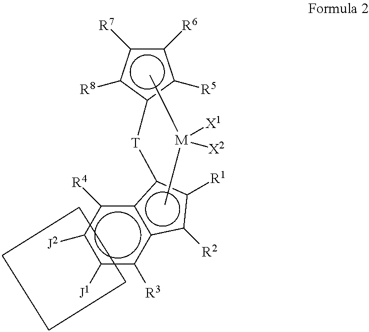

The unsaturated ring in indacenyl or hexahydrobenz[f]indenyl groups can be substituted or unsubstituted and can be part of multi-cyclic groups where the additional cyclic groups may be saturated or unsaturated, and substituted or unsubstituted. Typical substituents on the unsaturated ring include C₁ to C₄₀ hydrocarbyls (which may be substituted or unsubstituted), heteroatoms (such as halogens, such as Br, F, Cl), heteroatom-containing groups (such as a halocarbyl), or two or more substituents are joined together to form a cyclic or polycyclic ring structure (which may contain saturated and/or unsaturated rings), or a combination thereof.

In some embodiments, each of J¹ and J² may be joined from an unsubstituted C₄-C₃₀ (alternately C₅-C₃₀, alternately C₆-C₂₀) cyclic or polycyclic ring, either of which may be saturated, partially saturated, aromatic, or unsaturated. In some embodiments each J joins to form a substituted C₄-C₂₀ cyclic or polycyclic ring, either of which may be saturated or unsaturated. Examples include structures represented by Formulas 3-5 below:

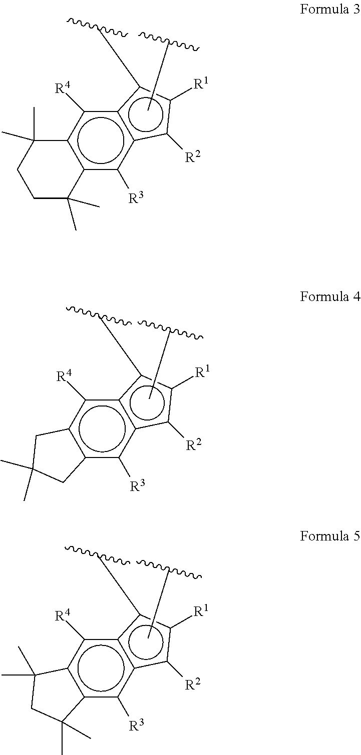

where R¹, R², R³ and R⁴ are as defined in Formula 1 above, and the wavy lines indicate connection to M (such as Hf or Zr) and T (such as Me²Si).

In some embodiments, M is a transition metal such as a transition metal of Group 3, 4, or 5 of the Periodic Table of Elements, such as a Group 4 metal, for example Zr, Hf, or Ti.

In some embodiments, each of X¹ and X² is independently an unsubstituted C₁-C₄₀ hydrocarbyl (such as an unsubstituted C₂-C₂₀ hydrocarbyl), a substituted C₁-C₄₀ hydrocarbyl (such as a substituted C₂-C₂₀ hydrocarbyl), an unsubstituted C₄-C₆₂ aryl, a substituted C₄-C₆₂ aryl, an unsubstituted C₄-C₆₂ heteroaryl, a substituted C₄-C₆₂ heteroaryl, hydride, amide, alkoxide, sulfide, phosphide, halide, diene, amine, phosphine, ether, and a combination thereof, for example each of X¹ and X² is independently a halide or a C₁-C₅ alkyl, such as methyl. In some embodiments, each of X¹ and X² is independently chloro, bromo, methyl, ethyl, propyl, butyl, pentyl, hexyl, heptyl, octyl, nonyl, decyl, undecyl, or dodecyl. In some embodiments of the present disclosure, X¹ and X² form a part of a fused ring or a ring system.

In some embodiments, T is represented by the formula, (R*₂G)g, wherein each G is C, Si, or Ge, g is 1 or 2, and each R* is, independently, hydrogen, halogen, an unsubstituted C1-C20 hydrocarbyl (such as methyl, ethyl, propyl, butyl, pentyl, hexyl, heptyl, octyl, nonyl, decyl, undecyl, or dodecyl), a substituted C₁-C₂₀ hydrocarbyl, or the two or more R* may join to form a substituted or unsubstituted, saturated, partially unsaturated or aromatic, cyclic or polycyclic substituent. In some embodiments of the present disclosure, T is a bridging group and is represented by R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′C′═CR′, R′C═CR′CR′₂CR′₂, R′₂CSiR′₂, R′₂SiSiR′₂, R₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—C′═CR′, R′₂C—S—CR′₂, R′₂CR′₂C—S—CR′₂CR′₂, R′₂C—S—CR′₂CR′₂, R′₂C—S—C′═CR′, R′₂C—Se—CR′₂, R′₂CR′₂C—Se—CR′₂CR′₂, R′₂C—Se—CR₂CR′₂, R′₂C—Se—CR′—CR′, R′₂C—N═CR′, R′₂C—NR′—CR′₂, R′₂C—NR′—CR′₂CR′₂, R′₂C—NR′—C′═CR′R′CR′CNR′CR′CR′R′CPCR′, or R′₂C—PR′—CR′₂ where each R′ is independently hydrogen or an unsubstituted C₁-C₂₀ hydrocarbyl (such as methyl, ethyl, propyl, butyl, pentyl, hexyl, heptyl, octyl, nonyl, decyl, undecyl, or dodecyl), a substituted C₁-C₂₀ hydrocarbyl, a C₁-C₂₀ halocarbyl, a C₁-C₂₀ silylcarbyl, or a C₁-C₂₀ germylcarbyl substituent, or two or more adjacent R′ join to form a substituted or unsubstituted, saturated, partially unsaturated or aromatic, cyclic or polycyclic substituent. In some embodiments of the present disclosure, T is a bridging group that includes carbon or silicon, such as dialkylsilyl; for example T may be a CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, or Si(CH₂)₄.

In some embodiments, R¹ is hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), for example hydrogen, a substituted C₁-C₆ hydrocarbyl, or an unsubstituted C₁-C₆ hydrocarbyl.

In some embodiments, each of R² and R⁴ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), for example hydrogen, a substituted C₁-C₆ hydrocarbyl, or an unsubstituted C₁-C₆ hydrocarbyl.

In some embodiments, each of R⁵, R⁶, R⁷, and R⁸ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or one or more of R⁵ and R⁶, R⁶ and R⁷, or R⁷ and R⁸ can be joined to form a substituted or unsubstituted C₄-C₂₀ saturated or unsaturated cyclic or polycyclic ring structure, or a combination thereof.

In some embodiments, one or more of R⁵ and R⁶, R⁶ and R⁷, or R⁷ and R⁸ can be joined to form a substituted or unsubstituted C₅-C₈ saturated or unsaturated cyclic or polycyclic ring structure, or a combination thereof.

In some embodiments, R³ is an unsubstituted C₄-C₂₀ cycloalkyl (e.g., cyclohexane, cyclypentane, cycloocatane, adamantane), or a substituted C₄-C₂₀ cycloalkyl.

In some embodiments, R³ is a substituted or unsubstituted phenyl, benzyl, carbazolyl, naphthyl, or fluorenyl.

In some embodiments R³ is a substituted or unsubstituted aryl group represented Formula 6:

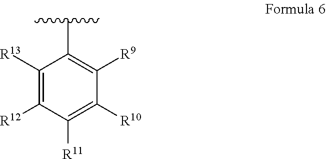

wherein each of R⁹, R¹⁰, R¹¹, R¹², and R¹³ is independently hydrogen, an unsubstituted C₁-C₄₀ hydrocarbyl, a substituted C₁-C₄₀ hydrocarbyl, a heteroatom, a heteroatom-containing group, or two or more of R⁹, R¹⁰, R¹¹, R¹², and R¹³ are joined together to form a C₄-C₆₂ cyclic or polycyclic ring structure, or a combination thereof.

In some embodiments of the present disclosure, each of R⁹, R¹⁰, R¹¹, R¹², and R¹³ is independently hydrogen, a halogen, an unsubstituted C₁-C₄₀ hydrocarbyl, a substituted C₁-C₄₀ hydrocarbyl, an unsubstituted C₄-C₆₂ aryl (such as an unsubstituted C₄-C₂₀ aryl, such as a phenyl), a substituted C₄-C₆₂ aryl (such as a substituted C₄-C₂₀ aryl), an unsubstituted C₄-C₆₂ heteroaryl (such as an unsubstituted C₄-C₂₀ heteroaryl), a substituted C₄-C₆₂ heteroaryl (such as a substituted C₄-C₂₀ heteroaryl), —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R⁹, R¹⁰, R¹¹, R¹², and R¹³ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more of R⁹, R¹⁰, R¹¹, R¹², and R¹³ can be joined to form a substituted or unsubstituted C₄-C₂₀ saturated or unsaturated cyclic or polycyclic ring structure, or a combination thereof.

In some embodiments of the present disclosure, at least one of R⁹, R¹⁰, R¹¹, R¹², and R¹³ is a phenyl or substituted phenyl group.

In some embodiments, suitable catalyst compounds may have a structure represented by Formula 7

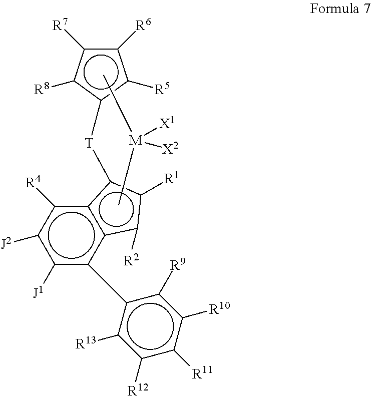

wherein M, T, J¹, J², X¹, X², R¹, R², R⁴, R⁵, R⁶, R⁷, and R⁸ are as described in Formula 1 and R⁹, R¹⁰, R¹¹, R¹², and R¹³ are as described in Formula 6.

In some embodiments, suitable catalyst compounds may have a structure represented by Formula 8:

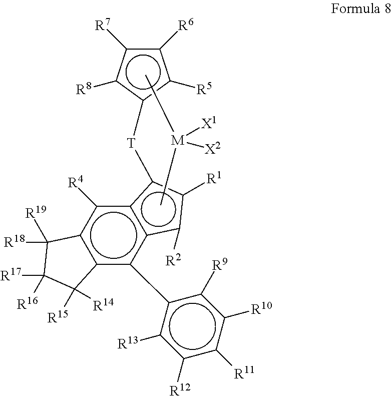

wherein each of R¹⁴, R¹⁵, R¹⁶, R¹⁷, R¹⁸, and R¹⁹ is independently hydrogen, an unsubstituted C₁-C₄₀hydrocarbyl, a substituted C₁-C₄₀ hydrocarbyl, a heteroatom, a heteroatom-containing group, or two or more of R¹⁴, R¹⁵, R¹⁶, R¹⁷, R¹⁸, and R¹⁹ are joined together to form a cyclic or polycyclic ring structure, or a combination thereof; and wherein M, T, J¹, J², X¹, X², R¹, R², R⁴, R⁵, R⁶, R⁷, and R⁸ are as described in Formula 1 and R⁹, R¹⁰, R¹¹, R¹², and R¹³ are as described in Formula 6.

In some embodiments, each of R¹⁴, R¹⁵, R¹⁶, R¹⁷, R¹⁸, and R¹⁹ is independently hydrogen, a halogen, an unsubstituted C₁-C₄₀ hydrocarbyl, a substituted C₁-C₄₀ hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R¹⁴, R¹⁵, R¹⁶, R¹⁷, R¹⁸, and R¹⁹ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more of R¹⁴, R¹⁵, R¹⁶, R¹⁷, R¹⁸, and R¹⁹ can be joined to form a substituted or unsubstituted C₄-C₂₀ saturated or unsaturated cyclic or polycyclic ring structure, or a combination thereof.

In some embodiments of the present disclosure, suitable catalyst compounds may have a structure represented by Formula 9:

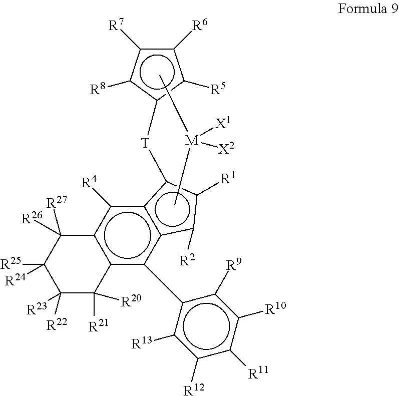

wherein each of R²⁰, R²¹, R²², R²³, R²⁴, R²⁵, R²⁶, R²⁷ is independently hydrogen, an unsubstituted C₁-C₄₀ hydrocarbyl, a substituted C₁-C₄₀ hydrocarbyl, a heteroatom, a heteroatom-containing group, or two or more of R²⁰, R²¹, R²², R²³, R²⁴, R²⁵, R²⁶, R²⁷ are joined together to form a cyclic or polycyclic ring structure, or a combination thereof; and wherein M, T, J¹, J², X¹, X², R¹, R², R⁴, R⁵, R⁶, R⁷, and R⁸ are as described in Formula 1 and R⁹, R¹⁰, R¹¹, R¹², and R¹³ are as described in Formula 6.

In some embodiments, each of R²⁰, R²¹, R²², R²³, R²⁴, R²⁵, R²⁶, R²⁷ is independently hydrogen, a halogen, an unsubstituted C₁-C₄₀ hydrocarbyl, a substituted C₁-C₄₀ hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R²⁰, R²¹, R²², R²³, R²⁴, R²⁵, R²⁶, R²⁷ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more R²⁰, R²¹, R²², R²³, R²⁴, R²⁵, R²⁶, R²⁷ can be joined to form a substituted or unsubstituted C₄-C₂₀ saturated or unsaturated cyclic or polycyclic ring structure, or a combination thereof.

In non-limiting examples, suitable catalyst compounds may have structures represented by the following formulas.

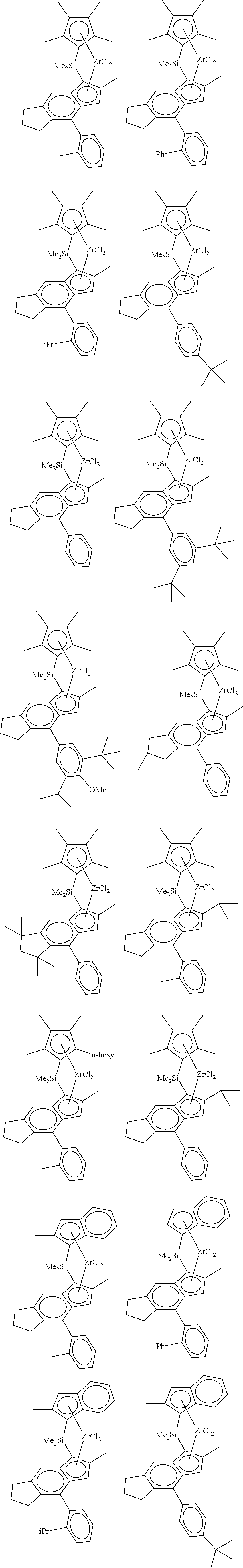

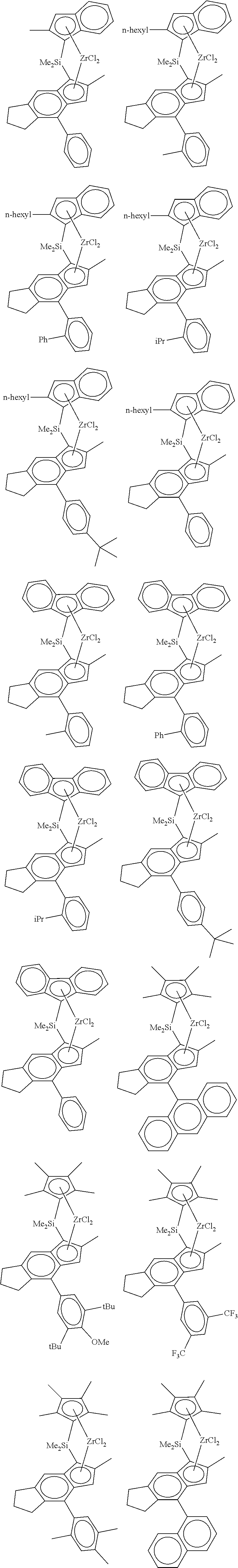

In at least one embodiment, the polymerization may be 1) conducted at temperatures of about 0° C. to about 300° C., or about 25° C. to about 150° C., or about 40° C. to about 120° C., or about 45° C. to about 80° C.; 2) conducted at a pressure of atmospheric pressure to about 10 MPa, or about 0.35 MPa to about 10 MPa, or about 0.45 MPa to about 6 MPa, or about 0.5 MPa to about 4 MPa; 3) conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; such as where aromatics can be present in the solvent at less than 1 wt %, such as less than 0.5 wt %, such as at 0 wt % based upon the weight of the solvents); 4) wherein the catalyst system used in the polymerization comprises less than 0.5 mol %, such as 0 mol % alumoxane, alternatively the alumoxane is present at a molar ratio of aluminum to transition metal less than 500:1, such as less than 300:1, or less than 100:1, or less than 1:1; 5) the polymerization occurs in one reaction zone; 6) the productivity of the catalyst compound is at least 80,000 g/mmol/hr (such as at least 150,000 g/mmol/hr, or at least 200,000 g/mmol/hr, or at least 250,000 g/mmol/hr, or at least 300,000 g/mmol/hr); 7) optionally scavengers (such as trialkylaluminum compounds) are absent (e.g., present at 0 mol %, alternatively the scavenger is present at a molar ratio of scavenger metal to transition metal of less than 100:1, such as less than 50:1, or less than 15:1, or less than 10:1); and/or 8) optionally hydrogen is present in the polymerization reactor at a partial pressure of 0.001 psig to 50 psig (0.007 kPa to 345 kPa) (such as from 0.01 psig to 25 psig (0.07 kPa to 172 kPa), or 0.1 psig to 10 psig (0.7kPa to 70 kPa)). In at least one embodiment, the catalyst system used in the polymerization comprises no more than one catalyst compound. A “reaction zone,” also referred to as a “polymerization zone,” is a vessel where polymerization takes place, for example a batch reactor. When multiple reactors arc used in either series or parallel configuration, each reactor is considered as a separate polymerization zone. For a multi-stage polymerization in both a batch reactor and a continuous reactor, each polymerization stage is considered as a separate polymerization zone. In at least one embodiment, the polymerization occurs in one reaction zone.

Other additives discussed herein may also be used in the polymerization, as desired, such as one or more scavengers, promoters, modifiers, reducing agents, oxidizing agents, hydrogen, aluminum alkyls, silanes, or chain transfer agents (such as alkylalumoxanes, a compound represented by the formula AlR₃ or ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof).

The catalyst systems described herein may comprise a catalyst as described above and an activator such as alumoxane or a non-coordinating anion and may be formed by combining the catalyst components described herein with activators in any suitable manner, including combining them with supports, such as silica. The catalyst systems may also be added to or generated in solution polymerization or bulk polymerization (in the monomer). Catalyst systems of the present disclosure may have one or more activators and one, two, or more catalyst components. Activators are defined to be any compound which can activate any one of the catalyst compounds described above by converting the neutral metal compound to a catalytically active metal compound cation. Non-limiting activators, for example, may include alumoxanes, aluminum alkyls, ionizing activators, which may be neutral or ionic, and conventional-type cocatalysts. Suitable activators may include alumoxane compounds, modified alumoxane compounds, and ionizing anion precursor compounds that abstract a metal ligand to make the metal compound cationic and provide a charge-balancing non-coordinating or weakly coordinating anion, e.g., a non-coordinating anion.

In at least one embodiment, the catalyst system can include an activator and a catalyst compound defined as above.

Alumoxane activators may be utilized as activators in the catalyst systems described herein. Alumoxanes are generally oligomeric compounds containing —Al(Ra)—O— sub-units, where Ra is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, such as when the abstractable ligand is an alkyl, halide, alkoxide or amide. Mixtures of different alumoxanes and modified alumoxanes may also be used. It may be suitable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3 A, covered under patent number U.S. Pat. No. 5,041,584, which is incorporated by reference herein). Another useful alumoxane is solid polymethylaluminoxane as described in U.S. Pat. Nos. 9,340,630, 8,404,880, and 8,975,209, which are incorporated by reference herein.

When the activator is an alumoxane (modified or unmodified), at least one embodiment selects the maximum amount of activator at up to a 5,000-fold molar excess Al/M over the catalyst compound (per metal catalytic site). The minimum activator-to-catalyst-compound can be a 1:1 molar ratio. Alternative ranges may include from 1:1 to 500:1, or 1:1 to 200:1, or 1:1 to 100:1, or 1:1 to 50:1.

In an alternative embodiment, little or no alumoxane is used in the polymerization processes described herein. For example, alumoxane can be present at 0 mol %, alternatively the alumoxane can be present at a molar ratio of aluminum to catalyst compound transition metal less than 500:1, such as less than 300:1, or less than 100:1, or less than 1:1.

The term “non-coordinating anion” (NCA) means an anion which either does not coordinate to a cation or which is only weakly coordinated to a cation thereby remaining sufficiently labile to be displaced by a Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization. Suitable ionizing activators may include an NCA, such as a compatible NCA.

It is within the scope of the present disclosure to use an ionizing activator, neutral or ionic. It is also within the scope of the present disclosure to use neutral or ionic activators alone or in combination with alumoxane or modified alumoxane activators. Suitable activators are described in U.S. Pat. Nos. 8,658,556 and 6,211,105.

The catalyst systems of the present disclosure can include at least one non-coordinating anion (NCA) activator. In at least one embodiment, boron containing NCA activators represented by Formula 10 can be used:

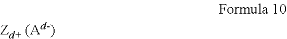

where Z is (L-H) or a reducible Lewis acid; L is a Lewis base; H is hydrogen; (L-H) is a Brønsted acid; A^{d}− is a boron containing non-coordinating anion having the charge d−; and d is 1, 2, or 3.

The cation component, Z₊ may include Brønsted acids such as protons or protonated Lewis bases or reducible Lewis acids capable of protonating or abstracting a moiety, such as an alkyl or aryl, from the bulky ligand transition metal catalyst precursor, resulting in a cationic transition metal species.

The activating cation Z_{d+} may also be a moiety such as silver, tropylium, carbeniums, ferroceniums and mixtures, such as carbeniums and ferroceniums. Z_{d+} can be triphenyl carbenium. Reducible Lewis acids can be a triaryl carbenium (where the aryl can be substituted or unsubstituted, such as those represented by the formula: (Ar₃C⁺), where Ar is aryl or aryl substituted with a heteroatom, a C₁ to C₄₀ hydrocarbyl, or a substituted C₁ to C₄₀ hydrocarbyl), such as the reducible Lewis acids “Z” may include those represented by the formula: (Ph₃C), where Ph is a substituted or unsubstituted phenyl, such as substituted with C₁ to C₄₀ hydrocarbyls or substituted a C₁ to C₄₀ hydrocarbyls, such as C₁ to C₂₀ alkyls or aromatics or substituted C₁ to C₂₀ alkyls or aromatics, such as Z is a triphenylcarbenium.

When Z_{d+} is the activating cation (L-H)_{d}, it can be a Brønsted acid, capable of donating a proton to the transition metal catalytic precursor resulting in a transition metal cation, including ammoniums, oxoniums, phosphoniums, silyliums, and mixtures thereof, such as ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, dioctadecylmethylamine, phosphoniums from triethylphosphine, triphenylphosphine, and diphenylphosphine, oxomiuns from ethers such as dimethyl ether, diethyl ether, tetrahydrofuran and dioxane, sulfoniums from thioethers, such as diethyl thioethers, tetrahydrothiophene, and mixtures thereof.

The anion component A^{d-} includes those having the formula [M^{k+}Qₙ]^{d-} where k is 1, 2, or 3; n is 1, 2, 3, 4, 5, or 6 (such as 1, 2, 3, or 4); n−k=d; M is an element selected from Group 13 of the Periodic Table of Elements, such as boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 50 (such as up to 20) carbon atoms with the optional proviso that in not more than 1 occurrence is Q a halide. Each Q can be a fluorinated hydrocarbyl group having 1 to 50 (such as 1 to 20) carbon atoms, such as each Q is a fluorinated aryl group, and such as each Q is a pentafluoryl aryl group. Examples of suitable A^{d-} also include diboron compounds as disclosed in U.S. Pat. No. 5,447,895, which is fully incorporated herein by reference.

Illustrative, but not limiting, examples of boron compounds which may be used as an activating cocatalyst are the compounds described as activators in U.S. Pat. No. 8,658,556, which is incorporated by reference herein.

The ionic stoichiometric activator Z_{d+} (A^{d-}) can be one or more of N,N-dimethylanilinium tetrakis(perfluorophenyl)borate, N,N-dimethylanilinium tetrakis(perfluoronaphthyl)borate, dioctadecylmethylammonium tetrakis(perfluorophenyl)borate N,N dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

Bulky activators are also useful herein as NCAs. “Bulky activator” as used herein refers to anionic activators represented by Formulas 11 and 12:

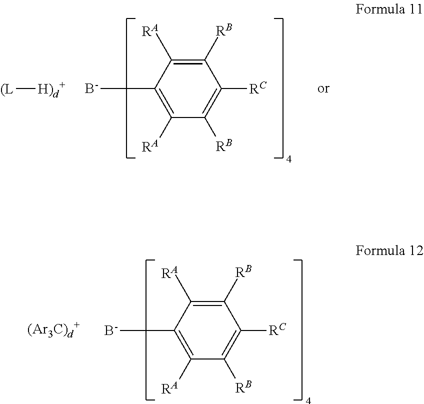

where each R^{A} is independently a halide, such as a fluoride; Ar is a substituted or unsubstituted aryl group (such as a substituted or unsubstituted phenyl), such as substituted with C₁ to C₄₀ hydrocarbyls, such as C₁ to C₂₀ alkyls or aromatics; each R^{B} is independently a halide, a C₆ to C₂₀ substituted aromatic hydrocarbyl group or a siloxy group of the formula —O—Si—R^{D}, where R^{D} is a C₁ to C₂₀ hydrocarbyl or hydrocarbylsilyl group (such as R^{B} is a fluoride or a perfluorinated phenyl group); each R^{C} is a halide, C₆ to C₂₀ substituted aromatic hydrocarbyl group or a siloxy group of the formula —O—Si—R^{D}, where R^{D} is a C₁ to C₂₀ hydrocarbyl or hydrocarbylsilyl group (such as R^{D} is a fluoride or a C₆ perfluorinated aromatic hydrocarbyl group); where R^{B} and R^{C} can form one or more saturated or unsaturated, substituted or unsubstituted rings (such as R^{B} and R^{C} form a perfluorinated phenyl ring); L is a Lewis base; (L-H)⁺ is a Brønsted acid; d is 1, 2, or 3; where the anion has a molecular weight of greater than 1,020 g/mol; and where at least three of the substituents on the B atom each have a molecular volume of greater than 250 cubic Å, alternatively greater than 300 cubic Å, or alternatively greater than 500 cubic Å.

For example, (Ar₃C) a can be (Ph₃C) d, where Ph is a substituted or unsubstituted phenyl, such as substituted with C₁ to C₄₀ hydrocarbyls or substituted C₁ to C₄₀ hydrocarbyls, such as C₁ to C₂₀ alkyls or aromatics or substituted C₁ to C₂₀ alkyls or aromatics.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in Girolami, G. S., “A Simple “Back of the Envelope” Method for Estimating the Densities and Molecular Volumes of Liquids and Solids,” Journal of Chemical Education, v. 71(11), November 1994, pp. 962-964, which is incorporated by reference herein. Molecular volume (MV), in units of cubic A, is calculated using the formula: MV=8.3 V_{S}, where V_{S} is the scaled volume. V_{S} is the sum of the relative volumes of the constituent atoms, and is calculated from the molecular formula of the substituent using the following table of relative volumes. For fused rings, the V_{S} is decreased by 7.5% per fused ring.

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

Suitable bulky activators are further described in U.S. Pat. No. 8,658,556, which is incorporated by reference herein.

In another embodiment, one or more of the NCA activators is chosen from the activators described in U.S. Pat. No. 6,211,105.

In at least one embodiment, the activator is selected from one or more of a triarylcarbonium (such as triphenylcarbenium tetraphenylborate, triphenylc arbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate triphenylcarbenium tetrakis(3,5-bis(trifluoromethyl)phenyl)borate).

In at least one embodiment, the activator is selected from one or more of trialkylammonium tetrakis(pentafluorophenyl)borate, N,N-dialkylanilinium tetrakis(pentafluorophenyl)borate, dioctadecylmethylammonium tetrakis(pentafluorophenyl)borate, dioctadecylmethylammonium tetrakis(perfluoronaphthyl)borate, N,N-dimethyl-(2,4,6-trimethylanilinium) tetrakis(pentafluorophenyl)borate, trialkylammonium tetrakis-(2,3,4,6-tetrafluorophenyl)borate, N,N-dialkylanilinium tetrakis-(2,3,4,6-tetrafluorophenyl)borate, trialkylammonium tetrakis(perfluoronaphthyl)borate, N,N-dialkylanilinium tetrakis(perfluoronaphthyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

In particularly useful embodiments, the activator is soluble in non-aromatic-hydrocarbon solvents, such as aliphatic solvents.

In one or more embodiments, a 20 wt % mixture of the activator compound in n-hexane, isohexane, cyclohexane, methylcyclohexane, or a combination thereof, forms a clear homogeneous solution at 25° C., preferably a 30 wt % mixture of the activator compound in n-hexane, isohexane, cyclohexane, methylcyclohexane, or a combination thereof, forms a clear homogeneous solution at 25° C.

In at least one embodiment, little or no alumoxane is used in the process to produce the polymers. Alumoxane can be present at 0 mol %, alternatively the alumoxane can be present at a molar ratio of aluminum to transition metal less than 500:1, such as less than 300:1, or less than 100:1, or less than 1:1.

In at least one embodiment, little or no scavenger is used in the process to produce the ethylene polymer. For example, scavenger (such as trialkylaluminum) can be present at 0 mol %, alternatively the scavenger can be present at a molar ratio of scavenger metal to transition metal of less than 100:1, such as less than 50:1, or less than 15:1, or less than 10:1.

In one or more embodiments, the activators described herein have a solubility of more than 10 mM, or more than 20 mM, or more than 50 mM at 25° C. (stirred 2 hours) in methylcyclohexane and/or a solubility of more than 1 mM, or more than 10 mM, or more than 20 mM at 25° C. (stirred 2 hours) in isohexane.

In a preferred embodiment, the activator is a non-aromatic-hydrocarbon soluble activator compound.

Non-aromatic-hydrocarbon soluble activator compounds useful herein include those represented by Formula 13:

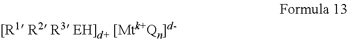

wherein E is nitrogen or phosphorous; d is 1, 2 or 3; k is 1, 2, or 3; n is 1, 2, 3, 4, 5, or 6; n−k=d (preferably d is 1, 2 or 3; k is 3; n is 4, 5, or 6); R^{1′}, R^{2′}, and R^{3′} are independently a C₁ to C₅₀ hydrocarbyl group optionally substituted with one or more alkoxy groups, silyl groups, a halogen atoms, or halogen containing groups, wherein R¹, R², and R³ together comprise 15 or more carbon atoms; Mt is an element selected from group 13 of the Periodic Table of Elements, such as B or Al, preferably boron; and each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Non-aromatic-hydrocarbon soluble activator compounds useful herein include those represented by Formulas 14 and 15:

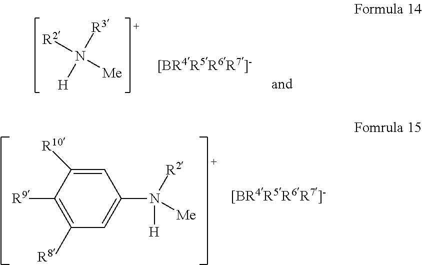

N is nitrogen; R^{2′} and R^{3′} are independently a C₆-C₄₀ hydrocarbyl group optionally substituted with one or more alkoxy groups, silyl groups, a halogen atoms, or halogen containing groups wherein R^{2′} and R^{3′} (if present) together comprise 14 or more carbon atoms; R^{8′}, R^{9′}, and R^{10′} are independently a C₄-C₃₀ hydrocarbyl or substituted C₄-C₃₀ hydrocarbyl group; B is boron; and R^{4′}, R^{5′}, R^{6′}, and R^{7′} are independently hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Optionally, R^{4′}, R^{5′}, R^{6′}, and R^{7′} may be pentafluorophenyl or pentafluoronaphthalenyl.

Optionally, R^{8′} and R^{10′} are hydrogen atoms and R^{9′} is a C₄-C₃₀ hydrocarbyl group which is optionally substituted with one or more alkoxy groups, silyl groups, a halogen atoms, or halogen containing groups. Optionally, R^{9′} is a C₈-C₂₂ hydrocarbyl group which is optionally substituted with one or more alkoxy groups, silyl groups, a halogen atoms, or halogen containing groups. Optionally, R^{2′} and R^{3′} are independently a C₁₂-C₂₂ hydrocarbyl group.

Optionally, R¹, R^{2′} and R^{3′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{2′} and R^{3′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{8′}, R^{9′}, and R^{10′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, when Q is a fluorophenyl group, then R^{2′} is not a C₁-C₄₀ linear alkyl group (alternately R^{2′} is not an optionally substituted C₁-C₄₀ linear alkyl group).

Optionally, each of R^{4′}, R^{5′}, R^{6′}, and R^{7′} is an aryl group (such as phenyl or naphthalenyl), wherein at least one of R^{4′}, R^{5′}, R^{6′} and R^{7′} is substituted with at least one fluorine atom, preferably each of R^{4′}, R^{5′}, R^{6′} and R″ is a perfluoroaryl group (such as perfluorophenyl or perfluoronaphthalenyl).

Optionally, each Q is an aryl group (such as phenyl or naphthalenyl), wherein at least one Q is substituted with at least one fluorine atom, and preferably each Q is a perfluoroaryl group (such as perfluorophenyl or perfluoronaphthalenyl).

Optionally, R^{1′} is a methyl group; R^{2′} is C₆-C₅₀ aryl group; and R^{3′} is independently C₁-C₄₀ linear alkyl or C₅-C₅₀-aryl group.

Optionally, each of R^{2′} and R^{3′} is independently unsubstituted or substituted with at least one of halide, C₁-C₃₅ alkyl, C₅-C₁₅ aryl, C₆-C₃₅ arylalkyl, C₆-C₃₅ alkylaryl, wherein R^{2′} and R^{3′} together comprise 20 or more carbon atoms.

Optionally, each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical, provided that when Q is a fluorophenyl group, then R^{2′} is not a C₁-C₄₀ linear alkyl group, preferably R^{2′} is not an optionally substituted C₁-C₄₀ linear alkyl group (alternately when Q is a substituted phenyl group, then R^{2′} is not a C₁-C₄₀ linear alkyl group, preferably R^{2′} is not an optionally substituted C₁-C₄₀ linear alkyl group). Optionally, when Q is a fluorophenyl group (alternately when Q is a substituted phenyl group), then R^{2′} is a meta- and/or para-substituted phenyl group, where the meta and para substituents are, independently, an optionally substituted C₁ to C₄₀ hydrocarbyl group (such as a C₆ to C₄₀ aryl group or linear alkyl group, a C₁₂ to C₃₀ aryl group or linear alkyl group, or a C₁₀ to C₂₀ aryl group or linear alkyl group), an optionally substituted alkoxy group, or an optionally substituted silyl group. Optionally, each Q is a fluorinated hydrocarbyl group having 1 to 30 carbon atoms, more preferably each Q is a fluorinated aryl (such as phenyl or naphthalenyl) group, and most preferably each Q is a perflourinated aryl (such as phenyl or naphthalenyl) group. Examples of suitable [Mt^{k+}Qₙ]^{d-} also include diboron compounds as disclosed in U.S. Pat. No. 5,447,895, which is fully incorporated herein by reference. Optionally, at least one Q is not substituted phenyl. Optionally all Q are not substituted phenyl. Optionally at least one Q is not perfluorophenyl. Optionally all Q are not perfluorophenyl.

In some embodiments, R^{1′} is not methyl, R^{2′} is not C₁₈ alkyl and R^{3′} is not C₁₈ alkyl, alternately R^{1′} is not methyl, R^{2′} is not C₁₈ alkyl and R^{3′} is not C₁₈ alkyl and at least one Q is not substituted phenyl, optionally all Q are not substituted phenyl.

Useful cation components include those represented by the following formulas.

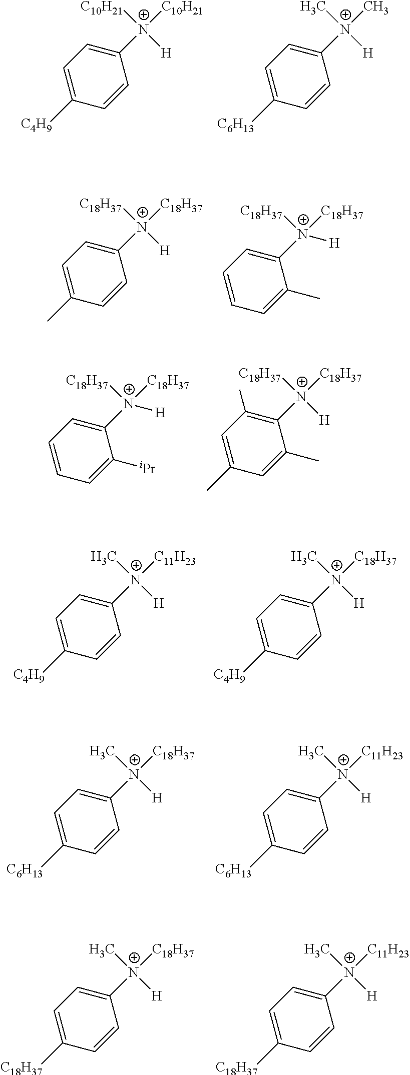

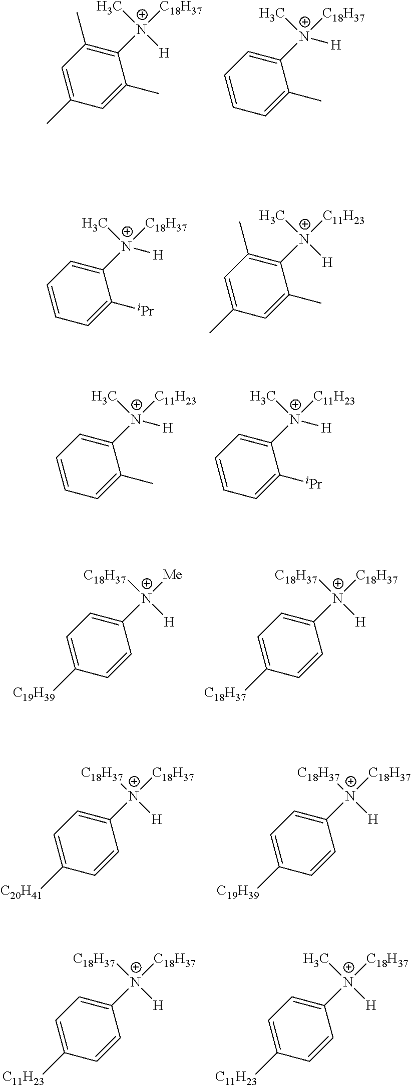

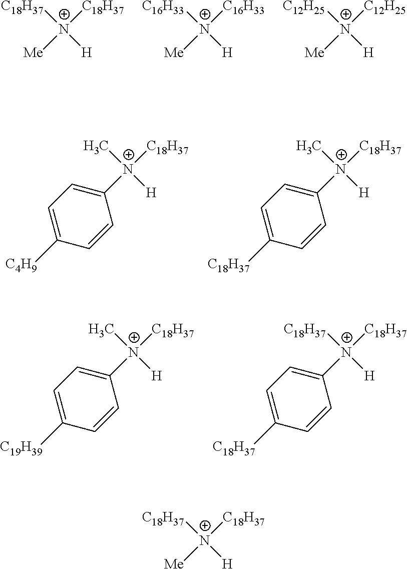

The anion component of the activators described herein preferably includes those represented by the formula [Mt^{k+}Qₙ]⁻ wherein k is 1, 2, or 3; n is 1, 2, 3, 4, 5, or 6 (preferably 1, 2, 3, or 4), (preferably k is 3; n is 4, 5, or 6, preferably when M is B, n is 4); Mt is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the provision that in not more than 1 occurrence is Q a halide. Preferably, each Q is a fluorinated hydrocarbyl group, optionally having 1 10 to 20 carbon atoms, more preferably each Q is a fluorinated aryl group, and most preferably each Q is a perfluorinated aryl group. Preferably at least one Q is not substituted phenyl, such as perfluorophenyl, preferably all Q are not substituted phenyl, such as perfluorophenyl.

Particularly useful activators include N-methyl-4-nonadecyl-N-octadecylbenzenaminium tetrakis(pentafluorophenyl)borate, N-methyl-4-nonadecyl-N-octadecylbenzenaminium tetrakis(perfluoronaphthalenyl)borate, and those disclosed in US 2019/0330139 and US 2019/0330392.

All NCA activators-to-catalyst ratio may be about a 1:1 molar ratio. Alternative ranges include from 0.1:1 to 100:1, or from 0.5:1 to 200:1, or 1:1 to 500:1, or 1:1 to 1000:1. Suitable ranges can be from 0.5:1 to 10:1, such as 1:1 to 5:1.

It is also within the scope of the present disclosure that the catalyst compounds can be combined with combinations of alumoxanes and NCAs (see for example, U.S. Pat. Nos. 5,153,157; 5,453,410; EP 0573120 B1; WO 1994/007928; and WO 1995/014044 which discuss the use of an alumoxane in combination with an ionizing activator).

Useful chain transfer agents can include hydrogen, alkylalumoxanes, a compound represented by the formula AlR₃, ZnR₂ (where each R is, independently, a C₁-C₈ aliphatic radical, such as methyl, ethyl, propyl, butyl, pentyl, hexyl octyl or an isomer thereof) or a combination thereof, such as diethylzinc, methylalumoxane, trimethylaluminum, triisobutylaluminum, trioctylaluminum, or a combination thereof.

Furthermore, a catalyst system of the present disclosure may include a metal hydrocarbonyl chain transfer agent represented by Formula 16:

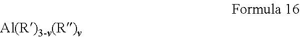

where each R′ can be independently a C₁-C₃₀ hydrocarbyl group, and/or each R″, can be independently a C₄-C₂₀ hydrocarbonyl group having an end-vinyl group; and v can be from 0.1 to 3.

In addition to these activator compounds, scavengers or coactivators may be used. Aluminum alkyl or alumoxane compounds which may be utilized as scavengers or coactivators may include, for example, trimethylaluminum, triethylaluminum, triisobutylaluminum, tri-n-hexylaluminum, tri-n-octylaluminum, diisobutylaluminum hydride, methylalumoxane (MAO), modified methylalumoxane (MMAO), MMAO-3A, and diethylzinc.

The catalyst system may include an inert support material. The supported material can be a porous support material, for example, talc, and inorganic oxides. Other support materials include zeolites, clays, organoclays, or another organic or inorganic support material, or mixtures thereof.

The support material can be an inorganic oxide in a finely divided form. Suitable inorganic oxide materials for use in catalyst systems herein may include groups 2, 4, 13, and 14 metal oxides, such as silica, alumina, and mixtures thereof. Other inorganic oxides that may be employed cither alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of about 10 m²/g to about 700 m²/g, pore volume of about 0.1 cm³/g to about 4.0 cm³/g and average particle size of about 5 mm to about 500 mm. The surface area of the support material can be of about 50 m²/g to about 500 m²/g, pore volume of about 0.5 cm³/g to about 3.5 cm³/g and average particle size of about 10 pm to about 200 mm. For example, the surface area of the support material can be from about 100 m²/g to about 400 m²/g, the pore volume can be from about 0.8 cm³/g to about 3.0 cm³/g and average particle size can be from about 5 pm to about 100 pm. The average pore size of the support material can be from 10 Å to 1000 Å, such as 50 Å to about 500 Å, or 75 Å to about 350 Å. In at least one embodiment, the support material may be a high surface area, amorphous silica (surface area=300 m²/gm; pore volume of 1.65 cm³/gm). For example, suitable silicas can be the silicas marketed under the tradenames of DAVISON™ 952 or DAVISON™ 955 by the Davison Chemical Division of W.R. Grace and Company. In other embodiments, DAVISON™ 948 may be used. Alternatively, a silica can be ES-70™ silica (PQ Corporation, Malvern, Pennsylvania) that has been calcined, for example (such as at 875° C.).

The support material may be dry, that is, free of absorbed water. Drying of the support material can be effected by heating or calcining at about 100° C. to about 1,000° C., such as at least about 600° C. When the support material is silica, the silica may be heated to at least 200° C., such as about 200° C. to about 850° C., and such as at about 600° C.; and for a time of about 1 minute to about 100 hours, from about 12 hours to about 72 hours, or from about 24 hours to about 60 hours. The calcined support material must have at least some reactive hydroxyl (OH) groups to produce supported catalyst systems of the present disclosure. The calcined support material is then contacted with at least one polymerization catalyst including at least one catalyst compound and an activator.

The support material, having reactive surface groups, such as hydroxyl groups, may be slurried in a non-polar solvent and the resulting slurry may be contacted with a solution of a catalyst compound and an activator. In at least one embodiment, the slurry of the support material is first contacted with the activator for a period of time from about 0.5 hours to about 24 hours, from about 2 hours to about 16 hours, or from about 4 hours to about 8 hours. The solution of the catalyst compound is then contacted with the isolated support/activator. In at least one embodiment, the supported catalyst system may be generated in situ. In an alternative embodiment, the slurry of the support material is first contacted with the catalyst compound for a period of time from about 0.5 hour to about 24 hours, from about 2 hours to about 16 hours, or from about 4 hours to about 8 hours. The slurry of the supported catalyst compound is then contacted with the activator solution.

The mixture of the catalyst, activator and support may be heated from about 0° C. to about 70° C., such as from about 23° C. to about 60° C., such as at room temperature. Contact times can be from about 0.5 hours to about 24 hours, such as from about 2 hours to about 16 hours, or from about 4 hours to about 8 hours.

Suitable non-polar solvents are materials in which all of the reactants used herein, e.g., the activator and the catalyst compound, are at least partially soluble and which are liquid at reaction temperatures. Non-polar solvents can include alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

Foamable compositions, Foaming Agents, Foamed Products, and Foaming Processes

The present disclosure describes foamable compositions comprising: a branched polypropylene copolymer having a g′ᵥᵢₛ of about 0.93 or less, or about 0.8 or less; and a foaming agent blended with the branched polypropylene copolymer, in which the branched polypropylene copolymer comprises a polymerized reaction product of propylene and an α,ω-diene having five or more carbon atoms. Foamed products may be produced by converting the foamable composition to a foamed form. Any of the foregoing branched polypropylene copolymers may be present therein.

The foamable compositions, foamed products, and foaming processes of the present disclosure invention may utilize a foaming agent to cause expansion of the branched polypropylene copolymers by foaming under specified conditions.

Suitable foaming agents may include both physical foaming agents and chemical foaming agents. Chemical foaming agents include, but are not limited to, azodicarbonamide, azodiisobutyronitrile, benzenesulfonhydrazide, 4,4-oxybenzene sulfonylsemicarbazide, p-toluenesulfonyl semicarbazide, barium azodicarboxylate, N,N′-dimethyl-N,N′-dinitrosoterephthalamide, trihydrazinotriazine, nitroso compounds, such as N,N′-dimethyl-N,N′-dinitrosoterephthalamide and N,N′-dinitrosopentamethylene tetramine; azo compounds, such as azodicarbonamide, azobisisobutylonitrile, azocyclohexylnitrile, azodiaminobenzene, and barium azodicarboxylate; sulfonyl hydrazide compounds, such as benzene sulfonyl hydrazide, toluene sulfonyl hydrazide, p,p′-oxybis(benzene sulfonyl hydrazide), and diphenyl sulfone-3,3′-disulfonyl hydrazide; and azide compounds, such as calcium azide, 4,4′-diphenyl disulfonyl azide, and p-toluene sulfonyl azide.

Suitable chemical foaming agents also include organic foaming agents including aliphatic hydrocarbons having 1-9 carbon atoms, halogenated aliphatic hydrocarbons, having 1-4 carbon atoms, and aliphatic alcohols having 1-3 carbon atoms. Aliphatic hydrocarbons include methane, ethane, propane, n-butane, isobutane, isobutene, n-pentane, isopentane, neopentane, and the like. Chemical foaming agents also include halogenated hydrocarbons such as chlorofluorocarbons, hydrochlorofluorocarbons, and preferably, fluorinated hydrocarbons. Examples of fluorinated hydrocarbon include methyl fluoride; perfluoromethane; ethyl fluoride; 1,1-difluoroethane (HFC-152a); 1,1,1-trifluoroethane (HFC-143a); 1,1,1,2-tetrafluoro-ethane (HFC-134a); pentafluoroethane; perfluoroethane; 2,2-difluoropropane; 1,1,1-trifluoropropane; perfluoropropane; perfluorobutane; and perfluorocyclobutane. Partially halogenated chlorocarbons and chlorofluorocarbons for use in this invention include methyl chloride; methylene chloride; ethyl chloride; 1,1,1-trichloroethane; 1,1-dichloro-1-fluoroethane (HCFC-141b); 1-chloro-1,1-difluoroethane (HCFC-142b); 1,1-dichloro-2,2,2-trifluoroethane (HCFC-123); and 1-chloro-1,2,2,2-tetrafluoroethane (HCFC-124). Fully halogenated chlorofluorocarbons include trichloromonofluoromethane (CFC-11); dichlorodifluoromethane (CFC-12); trichlorotrifluoroethane (CFC-113); dichlorotetrafluoroethane (CFC-114); chloroheptafluoropropane; and dichlorohexafluoropropane. Fully halogenated chlorofluorocarbons are not preferred. Aliphatic alcohols useful as foaming agents include methanol, ethanol, n-propanol, and isopropanol.

Suitable inorganic foaming agents include, but are not limited to, carbon dioxide, nitrogen, argon, water, air, nitrogen, and helium, and combinations thereof. Inorganic foaming agents also include sodium bicarbonate; sodium carbonate; ammonium bicarbonate; ammonium carbonate; and ammonium nitrite. Preferably, the foamable compositions may comprise nitrogen, n-butane, isobutane, n-pentane, isopentane, carbon dioxide, or any combination thereof in a suitable amount as a foaming agent.

The amount of foaming agent incorporated into the foamable compositions may range from about 0.01 wt % to about 10 wt %, based on total mass of the foamable composition, and preferably from about 0.1 wt % to about 5 wt %. The amount of foaming agent may be altered to obtain a desired foam density and/or cell size.

A foaming assistant can be used with the foaming agent. The simultaneous use of the foaming agent with a foaming assistant may contribute to lowering of the decomposition temperature of the foaming agent, acceleration of decomposition and homogenization of bubbles. Examples of the foaming assistant may include organic acids such as salicylic acid, phthalic acid, stearic acid and nitric acid, urea and derivatives thereof. The amount of foaming assistant incorporated into the foamable compositions may range from about 0.01 wt % to about 10 wt % and preferably from about 0.1 wt % to about 5 wt %, more preferably about 0.5 wt % to about 3 wt, %, based on total mass of the foamable composition.

The foamed products described herein may have a density of at least about 0.02 kg/cm³. Foam density is determined according to ASTM D1622-08.

Foamed products may comprise a foamed form having open cells, closed cells, or any combination thereof. The percentage of open or closed cells in a foamed product may be determined according to ASTM D2856-A.

The foamed product produced using the blends described herein typically have an average cell diameter of about 75 μm or less, according to ASTM D3576-04, preferably about 10 μm to about 75 μm, or about 15 μm to about 70 μm.

The foamed products described herein may have a cell density of about 10⁷ to about 10⁸ cells/cm³ at temperatures from about 120° C. to about 180° C., as measured by ASTM D1622-08. The foamed form may have a bulk density of about 0.1 g/cm³.

In other instances, the foamed products described herein may have an expansion ratio of about 30 to about 40 within a temperature range of about 110° C. to about 180° C. determined according to ASTM D792-13. Expansion ratio can be measured by dividing the density of the foamed form by the density of the polypropylene from which it originates. The foamed products may have a maximum expansion ratio within a temperature range of about 130° C. to about 155° C.

Polyolefin foams are commonly made by an extrusion process. Preferably, the extruders are longer than standard types, typically with an overall L/D (length to diameter) ratio>40, in either a single or tandem extruder configuration. Melt temperature is one parameter that may impact foam extrusion. Preferably, the melt temperature is in a range from approximately 130° C. to 180° C.

Foamed products may be produced from the foamable compositions by a number of processes, such as compression molding, injection molding, and hybrids of extrusion and molding. The processes may comprise mixing the branched polypropylene copolymers under heat to form a melt, along with foaming agents and other typical additives, to achieve a homogeneous or heterogeneous blend. The ingredients may be mixed and blended by any means known in the art, such as with a Banbury, intensive mixers, two-roll mill, extruder, or the like. Time, temperature, and shear rate may be regulated to ensure optimum dispersion without premature foaming. An excessive mixing temperature, for example, may result in premature foaming by decomposition of foaming agents or cell collapse due to lack of stabilization of the structure. When the melt temperature is too low, in contrast, foaming may be limited because the material solidifies before the cells have the possibility to expand fully. An adequate temperature is desired to promote good mixing of polymers and the dispersion of other ingredients. The upper temperature limit for safe operation may depend on the onset decomposition temperatures of foaming agents employed. The decomposition temperature of some foaming agents is lower than the melt temperature of the polymer. In this case, the polymers may be melt-blended before being compounded with other ingredient(s). The resultant mixture can be then compounded with the ingredients. Extruders with staged cooling/heating can be also employed. The latter part of the foam extruder is dedicated to the melt cooling and intimate mixing of the polymer-foaming agent system. After mixing, shaping can be carried out. Sheeting rolls or calendar rolls are often used to make appropriately dimensioned sheets for foaming. An extruder may be used to shape the composition into pellets. Foaming can be carried out in a compression mold at a temperature and time to complete the decomposition of foaming agents. Pressures, molding temperature, and heating time may be controlled. Foaming may also be carried out in an injection molding equipment by using foam composition in pellet form. The resulting foam can be further shaped to the dimension of finished products by any means known in the art, such as by thermoforming and compression molding.

Optionally, a nucleating agent may be blended in the polymer melt. The feeding rate of foaming agent and nucleating agent may be adjusted to achieve a relatively low density foam and small cell size, which results in a foam having thin cell walls.

In non-limiting embodiments, the in-reactor branched polypropylene copolymers may be utilized for producing injection molded components for automobiles, such as door panels, consoles, armrests, dashboards, seats, and headliners; especially where the component includes a foamed core covered by a soft-feeling, but scratch resistant, skin. Such components can be formed by employing separate injection molding operations to produce the core and the skin or may be produced in a single injection molding operation using commercially available multi-shot injection machinery.

It will be understood by those skilled in the art that the steps outlined above may be varied, depending upon the desired result. For example, the foamable compositions of the present disclosure may be directly thermoformed or blow molded without cooling, thus skipping a cooling step. Other parameters may be varied as well in order to achieve foamed product having desirable features.

### Additional Embodiments

Embodiments disclosed herein include:
A. Foamable compositions. The foamable compositions comprise: a branched polypropylene copolymer having a g′ᵥᵢₛ of about 0.93 or less; and a foaming agent blended with the branched polypropylene copolymer; wherein the branched polypropylene copolymer comprises a polymerized reaction product of propylene and an α,ω-diene having five or more carbon atoms. Optionally, the foamable compositions comprise: a branched polypropylene copolymer having a g′ᵥᵢₛ of about 0.8 or less; and a foaming agent blended with the branched polypropylene copolymer; wherein the branched polypropylene copolymer comprises a polymerized reaction product of propylene and an α,ω-diene having five or more carbon atoms. Optionally, the foamable compositions comprise: a branched polypropylene copolymer having a g′ᵥᵢₛ of about 0.8 or less.
B. Foamed products. The foamed products comprise the foamable compositions of A converted to a foamed form
C. Polymer foaming processes employing the foamable composition of A. The polymer foaming processes comprise: inducing foam formation with the foamable composition of A to produce a foamed product comprising a foamed form of the foamable composition of A.
C1. Polymer foaming processes comprising: introducing a foaming agent into a branched polypropylene copolymer having a g′ᵥᵢₛ value of about 0.93 or less to form a foamable composition; wherein the branched polypropylene copolymer comprises a polymerized reaction product of propylene and an α,ω-diene having five or more carbon atoms; and inducing foam formation within the foamable composition to produce a foamed product comprising a foamed form of the foamable composition. Optionally, the foamable compositions comprise: a branched polypropylene copolymer having a g′ᵥᵢₛ of about 0.8 or less.

Embodiments A, B, C, and C1 may have one or more of the following elements present in any combination.
Element 1: wherein the branched polypropylene copolymer has an Mz/Mw of about 6 or less.
Element 2: wherein the branched polypropylene copolymer has an Mw/Mn of about 9 or less.
Element 3: wherein the branched polypropylene copolymer has a melt flow rate of about 0.4 dg/min to about 56 dg/min, as determined by ASTM D1238-20 (2.16 kg at 230° C.). Optionally, the branched polypropylene copolymer has a melt flow rate of about 0.4 dg/min to about 3.6 dg/min, as determined by ASTM D1238-20 (2.16 kg at 230° C.).
Element 4: wherein the foaming agent comprises carbon dioxide, n-butane, isobutane, n-pentane, isopentane, nitrogen, or any combination thereof.
Element 5: wherein the foamable composition comprises about 0.1 wt % to about 10 wt % of the foaming agent, based on total mass of the foamable composition.
Element 6: wherein the branched polypropylene copolymer comprises about 99 wt % or about propylene and a non-zero amount of α,ω-diene, based on total mass of the branched polypropylene copolymer.
Element 7: wherein the branched polypropylene copolymer comprises about 0.0001 wt % to about 1 wt % of the α,ω-diene, based on total mass of the branched polypropylene copolymer.
Element 8: wherein the branched polypropylene copolymer has a gel stiffness of about 50Pa·s″ or greater.
Element 9: wherein the foamable composition has an expansion ratio of about 20 to about 40 within a temperature range of about 120° C. to about 170° C.
Element 10: wherein the foamable composition has a maximum expansion ratio within a temperature range of about 130° C. to about 155° C.
Element 11: wherein the foamed product has an average cell size of about 10 μm to about 75 μm.
Element 12: wherein the foamed product has an average cell density of about 10⁷ cells/cm³to about 10⁸ cells/cm³.
Element 13: wherein inducing foam formation comprises batch foaming, extrusion foaming, injection molding, blow molding, or any combination thereof.
Element 14: wherein branches are introduced to the branched polypropylene copolymer during a polymerization process producing the branched polypropylene copolymer.

The present disclosure further relates to the following non-limiting embodiments:

Embodiment 1. A foamable composition comprising: a branched polypropylene copolymer having a g′ᵥᵢₛ of about 0.93 or less; and a foaming agent blended with the branched polypropylene copolymer; wherein the branched polypropylene copolymer comprises a polymerized reaction product of propylene and an α,ω-diene having five or more carbon atoms.

Embodiment 2. The foamable composition of Embodiment 1, wherein the branched polypropylene copolymer has an Mz/Mw of about 6 or less.

Embodiment 3. The foamable composition of Embodiment 1 or Embodiment 2, wherein the branched polypropylene copolymer has an Mw/Mn of about 9 or less.

Embodiment 4. The foamable composition of any one of Embodiments 1 to 3, wherein the branched polypropylene copolymer has a melt flow rate of about 0.4 dg/min to about 56 dg/min, as determined by ASTM D1238-20 (2.16 kg at 230° C.).

Embodiment 5. The foamable composition of any one of Embodiments 1 to 4, wherein the foaming agent comprises carbon dioxide, n-butane, isobutane, n-pentane, isopentane, nitrogen, or any combination thereof.

Embodiment 6. The foamable composition of any one of Embodiments 1 to 5, wherein the foamable composition comprises about 0.1 wt % to about 10 wt % of the foaming agent, based on total mass of the foamable composition.

Embodiment 7. The foamable composition of any one of Embodiments 1 to 6, wherein the branched polypropylene copolymer comprises about 99 wt % or above propylene and a non-zero amount of α,ω-diene, based on total mass of the branched polypropylene copolymer.

Embodiment 8. The foamable composition of any one of Embodiments 1 to 7, wherein the branched polypropylene copolymer comprises about 0.0001 wt % to about 1 wt % of the α,ω-diene, based on total mass of the branched polypropylene copolymer.

Embodiment 9. The foamable composition of any of one Embodiments 1 to 8, wherein the branched polypropylene copolymer has a g′ᵥᵢₛ of about 0.8 or less.

Embodiment 10. The foamable composition of any one of Embodiments 1 to 9, wherein the branched polypropylene copolymer has a melt flow rate of about 0.4 dg/min to about 3.6 dg/min, as determined by ASTM D1238-20 (2.16 kg at 230° C.).

Embodiment 11. A foamed product comprising the foamable composition of any one of Embodiments 1 to 10 converted to a foamed form.

Embodiment 12. The foamed product of Embodiment 11, wherein the foamable composition of any one of Embodiments 1 to 10 has an expansion ratio of about 20 to about 40 within a temperature range of about 120° C. to about 170° C.

Embodiment 13. The foamed product of Embodiment 11 or Embodiment 12, wherein the foamable composition of any one of Embodiments 1 to 10 has a maximum expansion ratio within a temperature range of about 130° C. to about 155° C.

Embodiment 14. The foamed product of any one of Embodiments 11 to 13, wherein the foamed product has an average cell size of about 10 μm to about 75 μm.

Embodiment 15. The foamed product of any one of Embodiments 11 to 14, wherein the foamed product has an average cell density of about 10⁷ cells/cm³ to about 10⁸ cells/cm³.

Embodiment 16: The foamed product of any one of Embodiments 11 to 15, wherein the branched polypropylene copolymer has a g′ᵥᵢₛ value of about 0.8 or less.

Embodiment 17. A polymer foaming process comprising: introducing a foaming agent into a branched polypropylene copolymer having a g′ᵥᵢₛ value of about 0.93 or less to form a foamable composition; wherein the branched polypropylene copolymer comprises a polymerized reaction product of propylene and an α,ω-diene having five or more carbon atoms; and inducing foam formation within the foamable composition to produce a foamed product comprising a foamed form of the foamable composition.

Embodiment 18. The polymer foaming process of Embodiment 17, wherein inducing foam formation comprises batch foaming, extrusion foaming, injection molding, blow molding, or any combination thereof.

Embodiment 19. The polymer foaming process of Embodiment 17 or Embodiment 18, wherein the branched polypropylene copolymer has an Mz/Mw of about 6 or less.

Embodiment 20. The polymer foaming process of any one of Embodiments 17 to 19, wherein the branched polypropylene copolymer has an Mw/Mn of about 9 or less.

Embodiment 21. The polymer foaming process of any one of Embodiments 17 to 20, wherein the branched polypropylene copolymer has a melt flow rate of about 0.4 dg/min to about 56 dg/min as determined by ASTM D1238-20 (2.16 kg at 230° C.).

Embodiment 22. The polymer foaming process of any one of Embodiments 17 to 21, wherein the foaming agent comprises carbon dioxide, n-butane, isobutane, n-pentane, isopentane, nitrogen, or any combination thereof.

Embodiment 23. The polymer foaming process of any one of Embodiments 17 to 22, wherein the foamable composition comprises about 0.1 wt % to about 10 wt % of the foaming agent, based on total mass of the foamable composition.

Embodiment 24. The polymer foaming process of any one of Embodiments 17 to 23, wherein the branched polypropylene copolymer comprises about 99 wt % or above propylene and a non-zero amount of α,ω-diene, based on total mass of the branched polypropylene copolymer.

Embodiment 25. The polymer foaming process of any one of Embodiments 17 to 24, wherein the branched polypropylene copolymer comprises about 0.0001 wt % to about 1 wt % of the a, w-diene, based on total mass of the branched polypropylene copolymer.

Embodiment 26. The polymer foaming process of any one of Embodiments 17 to 25, wherein the foamable composition has an expansion ratio of about 20 to about 40 within a temperature range of about 120° C. to about 170° C.

Embodiment 27. The polymer foaming process of any one of Embodiments 17 to 26, wherein the foamed product has an average cell size of about 10 μm to about 75 μm and/or an average cell density of about 10⁷ cells/cm³ to about 10⁸ cells/cm³.

Embodiment 28. The polymer foaming process of any one of Embodiments 17 to 27, wherein branches are introduced to the branched polypropylene copolymer during a polymerization process producing the branched polypropylene copolymer.

Embodiment 29. The polymer foaming process of any one of Embodiments 17 to 28, wherein the branched polypropylene copolymer has a g′ᵥᵢₛ of about 0.8 or less.

Embodiment 30. The polymer foaming process of any one of Embodiments 17 to 29, wherein the branched polypropylene copolymer has a melt flow rate of about 0.4 dg/min to about 3.6 dg/min as determined by ASTM D1238-20 (2.16 kg at 230° C.).

To facilitate a better understanding of the embodiments of the present disclosure, the following examples of preferred or representative embodiments are given. In no way should the following examples be read to limit, or to define, the scope of the invention.

### EXAMPLES

Batch Polymerization Process. Polypropylene copolymers were prepared under the general batch conditions specified in WO 2021/034459, which is incorporated herein by reference. In brief, the following procedure was used.

A 1 L autoclave reactor equipped with a mechanical stirrer was used for polymer preparation. Prior to the run, the reactor was placed under nitrogen purge while maintaining 90° C. temperature for 30 minutes. Upon cooling back to ambient temperature, propylene feed (500 mL), scavenger (0.2 mL of 1 M TIBAL, triisobutylaluminum), 1,7-octadiene (0.05-0.5 mL, neat) and hydrogen (0.5-15 mmol) were introduced to the reactor and were allowed to mix for 5 minutes. Desired amount of supported catalyst (typically 12.5-25.0 mg) was then introduced to the reactor by flushing the pre-determined amount of catalyst slurry (5 wt % in mineral oil) from a catalyst tube with 100 mL of liquid propylene. The reactor was kept for 5 minutes at room temperature, before raising the temperature to 70° C. The reaction was allowed to proceed at that temperature for a desired time period (typically 30 min). After the given time, the temperature was reduced to 25° C., the excess propylene was vented off, and the polymer granules were collected and dried overnight. Additional reaction conditions are given in Table 1 below.

Continuous polymerization process. Polypropylene copolymers were produced in a pilot scale, continuous, bulk liquid system employing a 50 gallon stirred tank reactor equipped with a jacket for removing the heat of polymerization. Polymerization was conducted at a constant temperature of 70° C. under bulk conditions at varying levels of 1,7-octadiene and scavenger (triisobutylaluminum, TIBAL), as further specified in Table 2 below. The catalyst was fed as a 10 wt % slurry in oil at a feed rate of 13-17 cm³/hr.

Polymer Characterization. Unless otherwise indicated, the distribution and the moments of molecular weight (Mw, Mn, Mz, Mw/Mn, etc.), the comonomer content, and the branching index (g′ᵥᵢₛ) were determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering from about 2,700 cm⁻¹ to about 3,000 cm⁻¹ (representing saturated C—H stretching vibration), an 18-angle light scattering detector and a viscometer. Three Agilent PLgel 10-mm Mixed-B LS columns were used to provide polymer separation. Reagent grade 1,2,4-trichlorobenzene (TCB) (from Sigma-Aldrich) comprising ˜300 ppm antioxidant BHT was used as the mobile phase at a nominal flow rate of ˜1.0 mL/min and a nominal injection volume of ˜200 mL. The whole system including transfer lines, columns, and detectors was contained in an oven maintained at ˜145° C. A given amount of sample was weighed and sealed in a standard vial with −10 mL flow marker (heptane) added thereto. After loading the vial in the auto-sampler, the oligomer or polymer may automatically be dissolved in the instrument with ˜8 mL added TCB solvent at ˜160° C. with continuous shaking. The sample solution concentration was from ˜0.2 to ˜2.0 mg/ml, with lower concentrations being used for higher molecular weight samples. The concentration, c, at each point in the chromatogram was calculated from the baseline-subtracted IR5 broadband signal, l, using the equation: c=αl, where α is the mass constant determined with polyethylene or polypropylene standards. The mass recovery was calculated from the ratio of the integrated area of the concentration chromatography over elution volume and the injection mass which is equal to the pre-determined concentration multiplied by injection loop volume. The conventional molecular weight (IR MW) was determined by combining universal calibration relationship with the column calibration which is performed with a series of monodispersed polystyrene (PS) standards ranging from 700 to 10M gm/mole. The MW at each elution volume was calculated with Equation 2:

$$log M = \frac{log {K}_{PS} / K}{α + 1} + \frac{{α}_{ps} + 1}{α + 1} log {M}_{PS} \qquad Equation 2$$

where the variables with subscript “PS” stand for polystyrene while those without a subscript are for the test samples. In this method, α_{PS}=0.67 and K_{PS}=0.000175, α and K for other materials are as calculated as described in the published literature (e.g., Sun, T. et al. (2001) Macromolecules, v. 34, pg. 6812), except that for purposes of the present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, and α=0.695 and K=0.000181 for linear butane polymers. Concentrations are expressed in g/cm³, molecular weight is expressed in g/mole, and intrinsic viscosity (hence K in the Mark-Houwink equation) is expressed in dL/g unless otherwise noted.

The comonomer composition was determined by the ratio of the IR5 detector intensity corresponding to CH₂ and CH₃ channel calibrated with a series of PE and PP homo/copolymer standards whose nominal values are predetermined by NMR or FTIR. In particular, this provides the methyls per 1,000 total carbons (CH₃/1000TC) as a function of molecular weight. The short-chain branch (SCB) content per 1,000TC (SCB/1000TC) is then computed as a function of molecular weight by applying a chain-end correction to the CH₃/1000TC function, assuming each chain to be linear and terminated by a methyl group at each end. The weight % comonomer is then obtained from the Equation 3 in which f is 0.3, 0.4, 0.6, 0.8, and so on for C₃, C₄, C₆, C₈, and so on co-monomers, respectively:

$$w 2 = f \times S C B / 1000 T C \qquad Equation 3$$

The bulk composition of the polymer from the GPC-IR and GPC-4D analyses is obtained by considering the entire signals of the CH₃ and CH₂ channels between the integration limits of the concentration chromatogram. First, the following ratio in Equation 4 is obtained.

$$Bulk IR ratio = \frac{Area of {CH}_{3} signal within integration limits}{Area of {CH}_{2} signal within integration limits} . \qquad Equation 4$$

Then the same calibration of the CH₃ and CH₂ signal ratio, as mentioned previously in obtaining the CH₃/1000TC as a function of molecular weight, is applied to obtain the bulk CH₃/1000TC. A bulk methyl chain ends per 1000 total carbons (bulk CH₃end/1000TC) is obtained by weight averaging the chain-end correction over the molecular weight range, as shown in Equations 5 and 6.

$$w 2 b = f \times bulk {CH}_{3} / 1000 T C \qquad Equation 5$$

$$bulk S C B / 1000 T C = bulk {CH}_{3} / 1000 T C - bulk {CH}_{3} end / 1000 T C \qquad Equation 6$$

Bulk SCB/1000TC is then converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.) using Equation 7:

$$\frac{{K}_{o} c}{Δ R ( θ )} = \frac{1}{MP ( θ )} + 2 {A}_{2} c . \qquad Equation 7$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Kₒ is the optical constant for the system, as in Equation 8:

$${K}_{o} = \frac{4 {π}^{2} {{n}^{2} ( dn / dc )}^{2}}{{λ}^{4} {N}_{A}} \qquad Equation 8$$

where N_{A} is Avogadro's number, and (dn/dc) is the refractive index increment for the system. The refractive index, n, is 1.500 for TCB at 145° C. and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, was used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the equation [η]=ηₛ/c, where c is concentration and is determined from the IRS broadband channel output. The viscosity MW at each point is calculated using Equation 9.

$$M = {K}_{PS} {M}^{{α}_{PS} + 1} / [ η ] , \qquad Equation 9$$

where α_{PS} is 0.67 and K_{PS} is 0.000175.

The branching index (g′ᵥᵢₛ) was calculated using the output of the GPC-IRS-LS-VIS method as follows. The average intrinsic viscosity, [η]_{avg}, of the sample is calculated by Equation 10:

$${[ η ]}_{avg} = \frac{\sum {{c}_{i} [ η ]}_{i}}{\sum {c}_{i}} \qquad Equation 10$$

where the summations are over the chromatographic slices, i, between the integration limits. The branching index g′ᵥᵢₛ is defined in Equation 11:

$${g}_{vis}^{′} = \frac{{[ η ]}_{avg}}{{KM}_{v}^{α}} , \qquad Equation 11$$

where M_{V} is the viscosity-average molecular weight based on molecular weights determined by LS analysis and the K and α are for the reference linear polymer, which are, for purposes of the present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.000228 for linear propylene polymers, α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

Experimental and analysis details not described above, including how the detectors are calibrated and how to calculate the composition dependence of Mark-Houwink parameters and the second-virial coefficient, are further described by T. Sun, P. Brant, R. R. Chance, and W. W. Graessley (Macromolecules, 2001, Vol. 34(19), pp. 6812-6820.

Table 1 summarizes the reaction conditions used to produce branched polypropylene copolymers under batch conditions and further characterized below (Entries 1-6). Table 2 summarizes the reaction conditions used to produce branched polypropylene copolymers under continuous conditions and further characterized below (Entries 7-14). Table 3 summarizes physical properties of branched polypropylene copolymers produced in accordance with the procedures above and further specified in Tables 1 and 2.

TABLE 1

| | Catalyst | Hydrogen | 1,7-octadiene | Batch Reaction Time |
|---|---|---|---|---|
| Entry | [mg] | [mmol] | [mL] | [min] |
| 1 | 25.7 | 2 | 0.20 | 30 |
| 2 | 25.7 | 3 | 0.20 | 30 |
| 3 | 25.4 | 4 | 0.20 | 30 |
| 4 | 25.6 | 5 | 0.20 | 30 |
| 5 | 25.0 | 5 | 0.25 | 30 |
| 6 | 12.6 | 2 | 0.30 | 60 |

TABLE 2

| | Catalyst | | | | |
|---|---|---|---|---|---|
| | Feed | Hydrogen | 1,7- | | Residence |
| | Rate | [vapor phase | octadiene | TIBAL | time |
| Entry | [cm³/h] | conc., ppm] | [ppm] | [ppm] | [h] |
| 7 | 14.5 | 2066 | 0 | 30 | 1.4 |
| 8 | 15.4 | 2066 | 140 | 45 | 1.4 |
| 9 | 16.3 | 2066 | 220 | 80 | 1.4 |
| 10 | 17.4 | 2066 | 300 | 80 | 1.4 |
| 11 | 17.4 | 2066 | 400 | 80 | 1.4 |
| 12 | 16.3 | 2066 | 700 | 80 | 1.4 |
| 13 | 15.4 | 2066 | 700 | 100 | 1.4 |
| 14 | 14.5 | 2066 | 700 | 100 | 1.4 |

TABLE 3

| | Melt flow | | | | | | |
|---|---|---|---|---|---|---|---|
| | rate | | | | | | |
| | (2.16 kg, | | | | | | |
| | 230° C.) | Mn | Mw | Mz | Mw/ | Mz/ | |
| Entry | [dg/min] | [g/mol] | [g/mol] | [g/mol] | Mn | Mw | g′ᵥᵢₛ |
| 1 | 0.66 | 78,361 | 414,709 | 1,815,801 | 5.29 | 4.38 | 0.748 |
| 2 | 0.40 | 73,880 | 459,808 | 2,085,257 | 6.22 | 4.54 | 0.727 |
| 3 | 0.92 | 67,201 | 472,325 | 2,527,095 | 7.03 | 5.35 | 0.712 |
| 4 | 2.96 | 68,772 | 552,490 | 2,617,697 | 8.03 | 4.74 | 0.660 |
| 5 | 1.57 | 55,045 | 391,758 | 2,320,819 | 7.12 | 5.92 | 0.728 |
| 6 | 3.60 | 39,858 | 347,802 | 1,764,050 | 8.73 | 5.07 | 0.711 |
| 7 | 60 | 53,849 | 147,265 | 251,667 | 2.73 | 1.71 | 0.98 |
| 8 | 56 | 53,387 | 169,139 | 355,483 | 3.17 | 2.10 | 0.93 |
| 9 | 54 | 46,295 | 177,764 | 455,537 | 3.84 | 2.56 | 0.91 |
| 10 | 49 | 48,357 | 202,487 | 652,390 | 4.19 | 3.22 | 0.88 |
| 11 | 38 | 46,810 | 227,349 | 945,536 | 4.86 | 4.16 | 0.85 |
| 12 | 17 | 52,963 | 279,517 | 1,595,957 | 5.28 | 5.71 | 0.78 |
| 13 | 19 | 58,448 | 333,042 | 1,667,960 | 5.70 | 5.01 | 0.76 |
| 14 | 16 | 55,390 | 314,234 | 1,690,321 | 5.67 | 5.38 | 0.78 |

As shown, lower branching indices and higher molecular weights were obtained under the batch conditions tested. As the loading of 1,7-octadiene was increased under the continuous polymerization reactions, the molecular weight and g′ᵥᵢₛ values began to approach those obtained under batch conditions.

Small amplitude oscillatory shear (SAOS) data were collected. Dynamic shear melt rheological data were measured with an Advanced Rheometrics Expansion System (ARES-G2) from TA Instruments using parallel plates (diameter=25 mm) in a dynamic mode under nitrogen atmosphere. For all experiments, the rheometer was thermally stabilized at 190° C. for at least 30 minutes before inserting compression-molded sample (prepared at 190° C.) onto the parallel plates. To determine the samples viscoelastic behavior, frequency sweeps in the range from 0.01 to 628 rad/s were carried out at a temperature of 190° C. under constant strain. Depending on the molecular weight and temperature, strains in the linear deformation range verified by strain sweep test were used. A nitrogen stream was circulated through the sample oven to minimize chain extension or crosslinking during the experiments. A sinusoidal shear strain was applied to the sample if the strain amplitude was sufficiently small that the sample behaved linearly. It can be shown that the resulting steady-state stress will also oscillate sinusoidally at the same frequency but will be shifted by a phase angle δ with respect to the strain wave. The stress leads the strain by δ. For purely elastic materials δ=0° (stress is in phase with strain) and for purely viscous materials, δ=90° (stress leads the strain by 90° although the stress is in phase with the strain rate). For viscoelastic materials, 0<δ<90.

Rheological properties of the polypropylene were fit to a Winter-Chambon model using Equation 12,

$${η}^{*} ( ω ) = S Γ ( 1 - n ) {ω}^{n - 1} , \qquad Equation 12$$

wherein η* represents the complex viscosity (Pa·s), ω represents the frequency, Γ is the Gamma function, S is the gel stiffness, and n is the critical network relaxation exponent. Results are shown in Table 4. Based on the rheological profile, the polypropylenes may be characterized as having “gel-like” behavior.

TABLE 4

| | | Critical network | |
|---|---|---|---|
| | Gel stiffness, S | relaxation | Tan delta |
| Entry | [Pa · sⁿ] | exponent, n | at 0.01 rad/s |
| 1 | 4,820 | 0.48 | 0.81 |
| 2 | 3,579 | 0.51 | 0.96 |
| 3 | 1,902 | 0.60 | 1.37 |
| 4 | 2,080 | 0.62 | 1.92 |
| 5 | 1,304 | 0.63 | 1.7 |
| 6 | 5,170 | 0.50 | 0.99 |
| 7 | 17.5 | 0.95 | 427 |
| 8 | 33.2 | 0.93 | 157 |
| 9 | 41.6 | 0.91 | 68 |
| 10 | 67 | 0.9 | 84 |
| 11 | 100 | 0.87 | 47 |
| 12 | 374.5 | 0.77 | 6.2 |
| 13 | 334.4 | 0.77 | 6.4 |
| 14 | 344.2 | 0.77 | 6.3 |

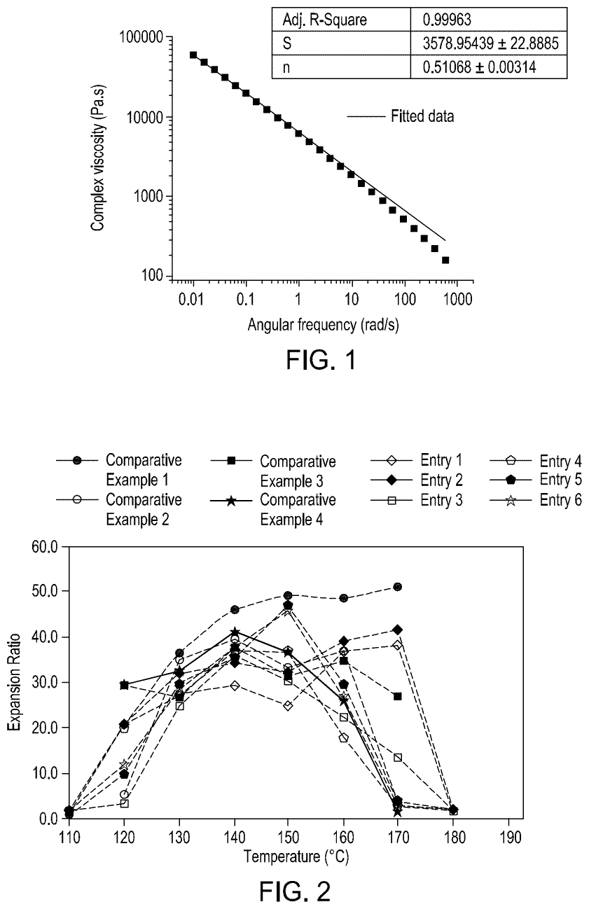

FIG. 1 is a graph of the small amplitude oscillatory shear (SAOS) data for the branched polypropylene copolymer of entry 2 fit to the Winter-Chambon model. As shown, the polymer samples produced under continuous polymerization conditions had somewhat different rheological parameters than did those produced under batch polymerization conditions. As the loading of 1,7-octadiene was increased in the continuous polymerization reactions under the conditions tested, the rheological parameters of the polymer samples produced under continuous polymerization conditions became closer to the values of those obtained under batch polymerization conditions.

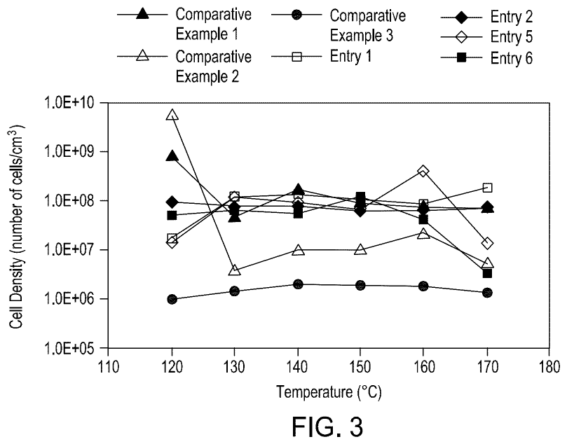

Batch Foaming Process. The foaming apparatus used herein consisted of a chamber in which the temperature was accurately controlled by a band heater with proportional-integral-derivative feedback control. A CO₂ gas cylinder was connected to the chamber through a pipeline, and a syringe pump was used to supply a metered stream of gas to maintain the internal CO₂ pressure at a constant 2000 psi. After preheating the chamber to 210° C., the branched polypropylene copolymer (0.1-0.2 g) was loaded and sealed in the chamber. CO₂ was injected into the chamber to saturate the branched polypropylene copolymer at 210° C. for a period of time dependent on the designated foaming temperature. Following CO₂ saturation, the heat supply was powered off, and the chamber was allowed to cool at a constant rate of 5.5° C./min until the designated foaming temperature was reached. The chamber was rapidly depressurized and quenched after a total of 18 minutes of CO₂ saturation and cooling. Expansion ratio data was collected over a range of foaming temperatures. FIG. 2 is a plot of expansion ratio as a function of temperature for branched polypropylene copolymers in comparison to various commercial polypropylenes. As shown, the branched polypropylene copolymers demonstrated ready foamability over a range of temperatures.

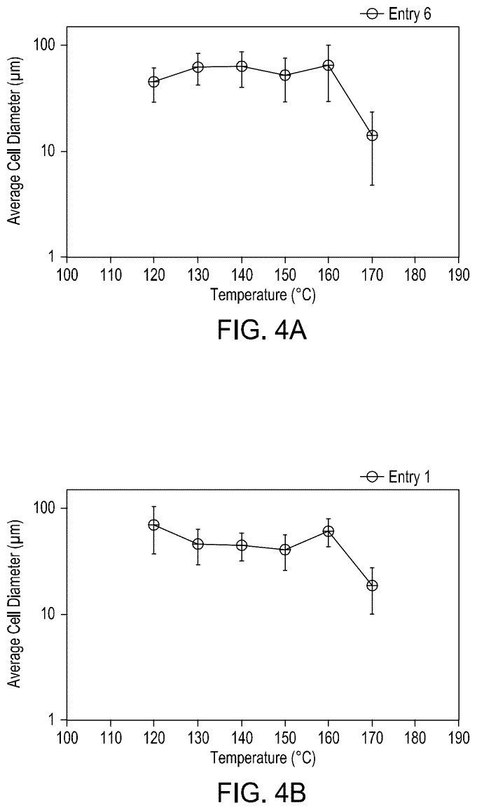

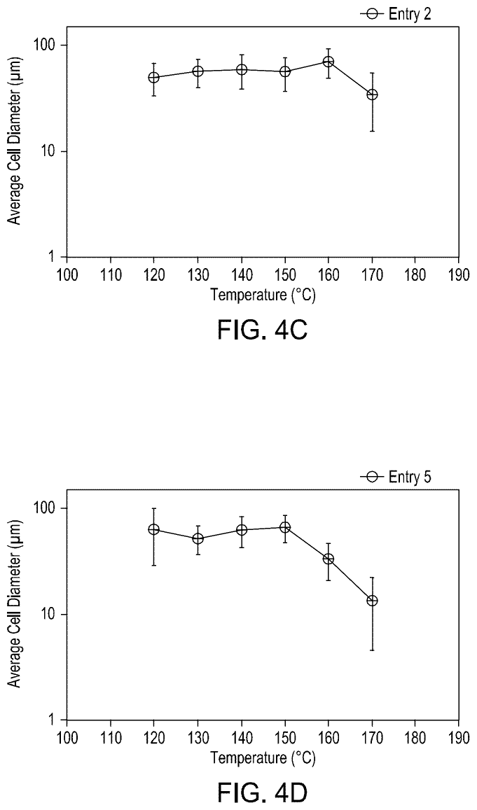

Cell morphology data of the foamed polypropylenes was collected via Scanning Electron Microscopy (SEM) in order to determine cell diameter and other related properties. FIG. 3 is a plot of average cell density as a function of temperature for various foamed polypropylenes in comparison to several commercial polypropylenes having a high melt strength. FIGS. 4A-4D are plots of average cell diameter as a function of temperature for various foamed polypropylenes. As shown, the average cell size was relatively constant at a level below 100 mm within a temperature range of 120° C. to 160° C.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1.-30. (canceled)

31. A foamable composition comprising:
a branched polypropylene copolymer having a g′ᵥᵢₛ of about 0.93 or less; and
a foaming agent blended with the branched polypropylene copolymer;
wherein the branched polypropylene copolymer comprises a polymerized reaction product of propylene and an α,ω-diene having five or more carbon atoms.

32. The foamable composition of claim 31, wherein the branched polypropylene copolymer has:
(a) an Mz/Mw of about 6 or less,
(b) an Mw/Mn of about 9 or less,
(c) a melt flow rate of about 0.4 dg/min to about 56 dg/min, as determined by ASTM D1238-20 (2.16 kg at 230° C.), or
(d) any combination of (a), (b), and (c).

33. The foamable composition of claim 31, wherein the foaming agent comprises carbon dioxide, n-butane, isobutane, n-pentane, isopentane, nitrogen, or any combination thereof and wherein the foamable composition comprises about 0.1 wt % to about 10 wt % of the foaming agent, based on total mass of the foamable composition.

34. The foamable composition of claim 31, wherein the branched polypropylene copolymer comprises about 99 wt % or above propylene and about 0.0001 wt % to about 1 wt % of the α,ω-diene, based on total mass of the branched polypropylene copolymer.

35. The foamable composition of claim 31, wherein the branched polypropylene copolymer has a g′ᵥᵢₛ of about 0.8 or less and wherein the branched polypropylene copolymer has a melt flow rate of about 0.4 dg/min to about 3.6 dg/min, as determined by ASTM D1238-20 (2.16 kg at 230° C.).

36. A foamed product comprising the foamable composition of claim 31 converted to a foamed form.

37. The foamed product of claim 36, wherein the foamable composition has an expansion ratio of about 20 to about 40 within a temperature range of about 120° C. to about 170° C.

38. The foamed product of claim 36, wherein the foamable composition has a maximum expansion ratio within a temperature range of about 130° C. to about 155° C.

39. The foamed product of claim 36, wherein the foamed product has an average cell size of about 10 μm to about 75 μm and an average cell density of about 10⁷ cells/cm³ to about 10⁸ cells/cm³.

40. The foamed product of claim 36, wherein the branched polypropylene copolymer has a g′ᵥᵢₛ of about 0.8 or less.

41. A polymer foaming process comprising:
introducing a foaming agent into a branched polypropylene copolymer having a g′ᵥᵢₛ value of about 0.93 or less to form a foamable composition;
wherein the branched polypropylene copolymer comprises a polymerized reaction product of propylene and an α,ω-diene having five or more carbon atoms; and
inducing foam formation within the foamable composition to produce a foamed product comprising a foamed form of the foamable composition.

42. The polymer foaming process of claim 41, wherein inducing foam formation comprises batch foaming, extrusion foaming, injection molding, blow molding, or any combination thereof.

43. The polymer foaming process of claim 41, wherein the branched polypropylene copolymer has:
(a) an Mz/Mw of about 6 or less,
(b) an Mw/Mn of about 9 or less,
(c) a melt flow rate of about 0.4 dg/min to about 56 dg/min, as determined by ASTM D1238-20 (2.16 kg at 230° C.), or
(d) any combination of (a), (b), and (c).

44. The polymer foaming process of claim 41, wherein the foaming agent comprises carbon dioxide, n-butane, isobutane, n-pentane, isopentane, nitrogen, or any combination thereof.

45. The polymer foaming process of claim 41, wherein the foamable composition comprises about 0.1 wt % to about 10 wt % of the foaming agent, based on total mass of the foamable composition.

46. The polymer foaming process of claim 41, wherein the branched polypropylene copolymer comprises about 99 wt % or above propylene and about 0.0001 wt % to about 1 wt % of the α,ω-diene, based on total mass of the branched polypropylene copolymer.

47. The polymer foaming process of claim 41, wherein the foamable composition has an expansion ratio of about 20 to about 40 within a temperature range of about 120° C. to about 170° C.

48. The polymer foaming process of claim 41, wherein the foamed product has an average cell size of about 10 μm to about 75 μm and/or an average cell density of about 10⁷ cells/cm³ to about 10⁸ cells/cm³.

49. The polymer foaming process of claim 41, wherein branches are introduced to the branched polypropylene copolymer during a polymerization process producing the branched polypropylene copolymer.

50. The polymer foaming process of claim 41, wherein the branched polypropylene copolymer has a g′ᵥᵢₛ of about 0.8 or less and a melt flow rate of about 0.4 dg/min to about 3.6 dg/min, as determined by ASTM D1238-20 (2.16 kg at 230° C.).
